(19) United States
(12) Patent Application Publication
(10) Pub. No.: US 2025/0341608 A1
(43) Pub. Date: Nov. 6, 2025

(54) INTERFERENCE CANCELLATION TO ESTIMATE DISTANCE IN CLUTTER DOMINATED ENVIRONMENT WITH BLUETOOTH CHANNEL SOUNDING (CS)

(71) Applicant: Cypress Semiconductor Corporation, San Jose, CA (US)

(72) Inventors: Avik SANTRA, Irvine, CA (US); Igor KRAVETS, Lviv (UA); Nazarii KOTLIAR, Kamianka-Buzka (UA); Ashutosh PANDEY, Irvine, CA (US)

(73) Assignee: Cypress Semiconductor Corporation, San Jose, CA (US)

(21) Appl. No.: 18/944,781

(22) Filed: Nov. 12, 2024

Related U.S. Application Data
(60) Provisional application No. 63/641,858, filed on May 2, 2024.

(51) Int. Cl. G01S 7/02; G01S 13/76; G01S 13/88

(52) U.S. Cl. CPC G01S 7/023; G01S 13/767; G01S 13/88

(57) ABSTRACT

Disclosed are techniques for successively cancelling interference in time-domain representation of I/Q phase measurement data based on detecting frequency peaks with maximum intensity or frequency peaks with maximum energy in frequency-domain for phase-based ranging (PBR). In one aspect, the frequency peaks may contain the maximum energy in least squares sense. An initiator of the PBR operating in a cluttered environment may identify at least an intensity or an index of a peak in a frequency-domain representation or a time-domain representation of the phase measurement data obtained between the initiator and a reflector. The initiator may remove the peak from a time-domain representation of the phase measurement data based on at least the intensity or the index of the peak to generate a residual time-domain representation. The initiator may estimate a range to the reflector based on the index of the peak or another peak derived from the residual time-domain representation.

### CROSS REFERENCE TO RELATED APPLICATIONS

This application claims the benefit of the filing date of U.S. Provisional Application No. 63/641,858 filed on May 2, 2024 by Applicant Cypress Semiconductor Corporation, the disclosure of which is incorporated herein by reference in its entirety.

### TECHNICAL FIELD

This disclosure generally relates to technologies for positioning and ranging using wireless signals, and more particularly, to interference cancellation techniques to provide sub-meter accuracy for point-to-point wireless positioning and ranging of a target of interest in an environment cluttered by interfering signals using narrow-band radios such as Bluetooth technologies.

### BACKGROUND

Ranging and localization applications such as secured entry, indoor positioning, asset tracking, etc., are increasingly relying on the use of narrow-band radios such as Bluetooth Low Energy (BLE) or IEEE 802.15.4 to provide sub-meter accuracy and secure distance measurements. For example, smart tags, smart phones, smart devices, Internet-of-Things (IoT) that use short-range BLE technologies for wireless communication may use BLE radios to perform ranging and positioning of other devices. In one such technique, two devices may calculate their range (also referred to as distance) by exchanging unmodulated pulses (also known as “constant tone” in the literature) and measuring the amount of signal-phase shifts between them. To mitigate multi-path fading, the two devices may measure phase shifts over multiple frequencies to achieve an acceptable accuracy. However, it is difficult for phase-based ranging solutions using unmodulated pulses to achieve centimeter ranging accuracy in an indoor environment. In a complex and dynamic indoor environment, signal propagation path to a target may be constantly changing due to the motion of the target and geometries of the indoor space, leading to reflections, diffraction, and multipath interference of the constant tone signals. Indoor environment are also subject to high interference due to other wireless devices operating in the same frequency bands, such as WiFi. It is desired to improve the accuracy of phase-based ranging solutions in an indoor or other dynamically changing environment.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram illustrating a transmitting device transmitting unmodulated pulses to a receiving device for the receiving device to measure the phase of the received signal in a multi-carrier PBR application, in accordance with one aspect of the present disclosure;

FIG. 2 is a signaling diagram illustrating an initiator device and a reflector device synchronizing timing and exchanging constant tone signals using Bluetooth LE CS application, and for the initiator device to process phase data measured by both devices to estimate a range between the devices, in accordance with one aspect of the present disclosure;

FIG. 3 illustrates two devices exchanging unmodulated pulse signals across multiple channels and measuring the phase shifts for the devices to estimate their mutual range, in accordance with one aspect of the present disclosure;

FIG. 4 illustrates an initiator estimating the distance (also known as ranging) to a reflector based on phases measured by the initiator and the reflector for two frequency tones (e.g., channels), in accordance with one aspect of the present disclosure;

FIG. 5 illustrates a block diagram of a processing pipeline used by an initiator device of a phase-based ranging application to estimate the range to a reflector device, in accordance with one aspect of the present disclosure;

FIG. 6 illustrates a block diagram of a preprocessing module of the processing pipeline used to remove errors and ambiguities in the I/Q measurement data prior to using the data for range estimation, in accordance with one aspect of the present disclosure;

FIG. 7 illustrates a block diagram of a scene identifier module of the processing pipeline used to calculate statistics of the I/Q measurement data and to identify the scene of the operating environment, in accordance with one aspect of the present disclosure;

FIG. 8 illustrates a block diagram of a feature selection module of the processing pipeline used to adaptively adjust a bandwidth of a confidence-based bandpass filter for filtering the I/Q measurement data based on a confidence level in the data points and the identified scene, in accordance with one aspect of the present disclosure;

FIG. 9 illustrates a block diagram of a feature transformation module of the processing pipeline implementing a minimum variance distortion-less response (MVDR) algorithm to transform the bandpass filtered I/Q measurement data from the frequency domain to the time domain as a function of the identified scene, in accordance with one aspect of the present disclosure;

FIG. 10 illustrates spatial smoothing of the covariance matrix of the bandpass filtered I/Q measurement data using the MVDR transformation, in accordance with one aspect of the present disclosure;

FIG. 11 illustrates a block diagram of a spectrum generation and range estimation module used to oversample the time-domain data to generate parallel initial range estimates as a function of the identified scene, in accordance with one aspect of the present disclosure;

FIG. 12 illustrates a block diagram of a processing pipeline used to successively cancel strongest detected peaks from a time-domain representation of the measurement data using a notch filter to uncover a list of the closest peaks in the time-domain for range estimation, in accordance with one aspect of the present disclosure;

FIG. 13 illustrates a flow diagram of a method of operating the processing pipeline of FIG. 12 to successively identify and cancel strongest detected peaks from a time-domain representation of the measurement data using a notch filter to reveal a closest peak location for use in estimating a range to a target device, in accordance with one aspect of the present disclosure;

FIG. 14 illustrates a block diagram of a processing pipeline used to successively remove frequency peaks estimated to contain the maximum energy in the least squares sense from a time-domain representation of the measurement data to uncover a list of the strongest peaks in the frequency domain for range estimation, in accordance with one aspect of the present disclosure;

FIG. 15 illustrates a flow diagram of a method of operating the processing pipeline of FIG. 14 to successively identify and remove strongest detected frequency peaks from a time-domain representation of the measurement data to generate a list of the strongest peaks in the frequency domain for use in estimating a range to a target device, in accordance with one aspect of the present disclosure;

FIG. 16 illustrates a flow diagram of a method for operating a device to identify and remove a detected frequency peak from the time-domain representation of phase measurement data to estimate a range between the device and a target device, in accordance with one aspect of the present disclosure;

FIG. 17 illustrates a functional block diagram of two Bluetooth devices that implement phase-based ranging using channel sounding (CS) and CS post-processor of the phase measurement data to estimate a range between the two devices, in accordance with one aspect of the present disclosure.

### DETAILED DESCRIPTION

Examples of various aspects and variations of the subject technology are described herein and illustrated in the accompanying drawings. The following description is not intended to limit the invention to these embodiments, but rather to enable a person skilled in the art to make and use this invention.

Described are systems and methods for improving the accuracy of phase-based ranging and tracking application in an indoor or other dynamically changing environment using Bluetooth Low Energy (BLE), IEEE 802.15.4, or other short-range narrow-band radio technologies. One implementation of such high accuracy positioning (HAP) applications uses multi-carrier phase-based ranging for distance measurement and positioning, also referred to as multi-carrier phase difference (MCPD) (or channel sounding (CS) in BLE), in which the two-way phase difference between two devices is measured over multiple carriers. In phase-based ranging (PBR), the two devices, the initiator and the reflector, exchange multiple unmodulated pulses (UP) (also referred to as constant tones in BLE) over different carrier frequencies to mitigate multi-path fading and interference. The initiator is the device that initiates the ranging and the reflector is the device that responds to the initiator request. In applications using phase-based ranging, the initiator and the reflector may perform phase measurements on each other's UP. For example, the initiator may send the UP toward the reflector for the reflector to measure the phase of the received UP. In turn, the reflector may send back its own UP toward the initiator for the initiator to measure the phase of the received UP. At the end of the multiple UP exchanges, the initiator and the reflector may exchange their phase measurement results to estimate the range between the initiator and the reflector. In multi-carrier phase-based ranging operations, the ranging and positioning measurements may be repeated over multiple channels.

PBR applications using UP are prone to errors in an indoor or other dynamic changing environment. In such an environment, a target of the ranging application, such as people, furniture, and equipment may move, or change, affecting signal propagation of the UP. An indoor environment may also have complex geometries, e.g., walls, corners, and other obstacles made of a myriad of materials, leading to reflections, diffractions, and multipath interference of signals. An indoor environment may also be teeming with other wireless devices operating in the same frequency bands as BLE, leading to channel interference.

Conventionally, estimation of a target range may involve transforming the phase measurements from the frequency domain to the time domain using techniques such as inverse fast Fourier transform (IFFT) to identify the earliest peak as the estimated target range. Alternatively, the estimation of the target range may involve determining a slope of the distribution of the phase measurements across the multiple channels (e.g., 72 1 MHz BLE data channels in the 2.4 GHz band) using a line-fit algorithm or linear regression technique. However, the width of the peak using the IFFT technique may be too wide or the slope of the phase measurements using the line-fit algorithm may be too noisy to yield the desired range accuracy in HAP applications. These techniques also do not handle out of distribution phase measurements or other anomalies attributed to the indoor environment.

Techniques described herein introduce a BLE channel sounding (CS) processing pipeline including a scene identifier module configured to process statistical properties of the phase (or I/Q) measurement data to identify the scene (e.g., indoor with dynamic variation, indoor with low variation, outdoor, etc.). When an indoor scene is identified, a feature selection module may adaptively adjust a bandwidth of a bandpass filter used to filter the phase (or I/Q) measurement data based on a level of confidence associated with the data. The level of confidence may be based on factors such as a signal-to-noise (SNR), uncertainty in measurement techniques or feedback from a Kalman filter, a variance of recent range estimates, etc. For data points with high confidence, the bandpass filter may operate with a narrower bandwidth to allow phase (or I/Q) measurement data with the most probable frequency components to pass through, reducing the influence of noise on the range estimates. For data points with low confidence, the bandpass filter may operate with a wider bandwidth to reduce the influence of potentially unreliable filtering on the range estimates.

The CS processing pipeline may include a feature transformation module implementing a minimum variance distortion-less response (MVDR) algorithm to transform the confidence-based bandpass filtered phase (or I/Q) measurement data from the frequency domain to the time domain as a function of the identified scene. The feature transformation module applies the MVDR algorithm normally reserved for beamforming to the domain of range estimation. A dimension of the covariance matrix of the input data may be a function of the identified scene and may be smaller than a number of frequency channels of the multi-carrier PBR. A steering vector for the MVDR may be defined for the desired range. The MVDR-based feature transformation generates a narrower peak in the time domain compared to that from IFFT technique, enabling better resolution of multipath components for detecting the closest target.

The CS processing pipeline may include a parallel moving average spectrum generation and range estimation module configured to oversample data from the MVDR-based feature transformation module for range estimation and faster Kalman Filter range estimate convergence. Multiple moving average spectrums, each one with a different smoothing factor, may generate smoothed spectral trend for range estimation. The smoothing factors may be adaptive to the identified scene, so a moving average spectrum may adapt faster to changes in the spectral trend for an indoor scene with dynamic variation. A range estimation algorithm may operate on each of the multiple moving average spectrum to estimate the respective range as a corresponding closest peak (e.g., earliest peak). The range estimation algorithm may also be a function of the identified scene. A Kalman Filter may operate on the estimated closest peaks corresponding to the multiple moving average spectrums to achieve faster convergence of the range estimates. The covariance matrix generated by the Kalman Filter representing the uncertainty in the state estimate may provide the confidence level feedback for the confidence-based bandpass filter of the feature selection module.

In one aspect, a successive interference cancellation module of the CS processing pipeline may successively identify frequency peaks of decreasing intensities for removal starting from the frequency peak with the maximum intensity based on a frequency transformation of the spectrum of measurement data in the time domain. In one embodiment, the feature transformation module or the parallel moving average spectrum generation and range estimation module of the CS processing pipeline may provide the spectrum of measurement data in the time domain. Based on the time locations of the identified frequency peaks, the successive interference cancellation module may generate a list of closest peak locations containing the indices of the sequentially closest peaks in the time-domain.

From an identified strongest frequency peak in the frequency domain, the successive interference cancellation module may determine an index in the time-domain corresponding to the identified strongest frequency peak. If the index is less than a minimum index in the list of closest peak locations, the identified peak is deemed to be closer than any peak in the list of closest peak locations. The successive interference cancellation module may add the index corresponding to the identified peak to the list of closest peaks locations.

The successive interference cancellation module may generate a notch filter around the location of the identified peak to remove the identified peak from the time-domain representation of the phase measurement data. In one embodiment, the notch filter may remove the identified peak from the output of the feature transformation module to generate residual time-domain data. The successive interference cancellation module may identify the next strongest frequency peak for removal based on a frequency transformation of the range estimates derived from the residual time-domain data. In one embodiment, the successive interference cancellation module may successively identify and remove additional peaks until a predefined maximum number of peaks have been removed or if the energy of the residual time-domain data drops below a minimum energy threshold. The successive interference cancellation module may update the list of closest peak locations in successive iterations. An estimation module may estimate the range to a target device based on the minimum index in the list of closest peak locations.

In another aspect, a successive least squares estimation module of the CS processing pipeline may successively identify frequency peaks for removal starting from the frequency peak with the maximum energy based on a frequency transformation of the spectrum of measurement data in the time domain. In one embodiment, the successive least squares estimation module may identify the frequency peak that if removed will remove the maximum energy in the least squares sense. Based on the locations and the intensities of the identified frequency peaks, the successive least squares estimation module may generate a list of the peak indices and peak intensities of the strongest peaks in the frequency-domain. The successive least squares estimation may identify the indices in the time-domain corresponding to the strongest peaks in the frequency-domain.

From an identified strongest frequency peak in the frequency domain, the successive least squares estimation module may determine a complex time-domain representation of the strongest frequency peak based on its location and intensity. The successive least squares estimation module may subtract the complex time-domain representation of the strongest peak from the time-domain representation of the phase measurement data. In one embodiment, the successive least squares estimation module may subtract the complex time-domain representation of the strongest peak from the output of the feature transformation to generate residual time-domain data.

The successive least squares estimation module may identify the next strongest frequency peak for removal based on a frequency transformation of the range estimates derived from the residual time-domain data. In one embodiment, the successive least squares estimation module may successively identify and remove additional strongest frequency peaks until a predefined maximum number of strongest frequency peaks have been removed or if the energy of the residual time-domain data drops below a minimum energy threshold. The successive least squares estimation module may update the list of the peak indices and peak intensities of the strongest frequency peaks in successive iterations. An estimation module may estimate the range to a target device based on the indices in the time-domain corresponding to the strongest frequency peaks in the list. A total number of the indices in the time-domain may correspond to a total number of strongest frequency peaks removed.

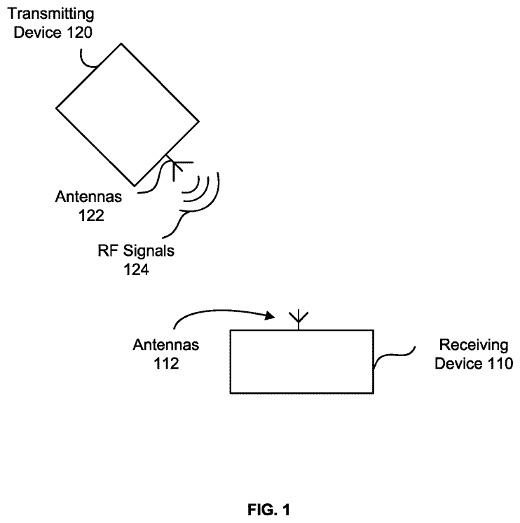

FIG. 1 is a block diagram illustrating a transmitting device transmitting unmodulated pulses (also referred to as constant tones) to a receiving device for the receiving device to measure the phase of the received signal in multi-carrier PBR, in accordance with one aspect of the present disclosure. The transmitting device 120 is shown to transmit through an antenna 122 unmodulated pulse RF signals 124 over multiple carrier frequencies. The receiving device 110 is coupled to an antennas 112 to receive the RF signals 124 to measure the phase of the received signals. The transmitting device 120 may be an initiator and the receiving device 110 may be a reflector. Conversely, the transmitting device 120 may be a reflector and the receiving device 110 may be an initiator. The reflector may be the target whose distance or range to the initiator is to be determined.

The transmitting device 120 may include circuitry to not only transmit RF signals but also to receive RF signals. Conversely, the receiving device 110 may include circuitry to not only receive RF signals but also to transmit RF signals. A phase-based ranging cycle may include multiple time-slots used by the two devices to exchange unmodulated pulses at different channels (e.g., different carrier frequencies) to estimate the distance. Each time-slot may include a receiving time interval during which a device receives an unmodulated pulse signal from the other device to measure its phase and a transmission time interval during which the first device transmits an unmodulated pulse signal for phase measurements by the other device. In each time-slot, the two devices 110 and 120 may exchange the unmodulated pulses in a different channel from the previous or the next time-slot.

The devices 110 and 120 may be connected as part of a Wireless Personal Area Network (WPAN), a Wireless Local Area Network (WLAN), or any other wireless networks. Communication protocols supported by the devices 110 and 120 may include, without limitation, Bluetooth (e.g., BLE), ZigBee, or Wi-Fi having frequencies in the Industrial, Scientific, and Medical (ISM) band. In one embodiment, the two devices may exchange 72 unmodulated pulse signals across the 80 MHz of the entire 2.4 GHz ISM band in BLE. In one embodiment, the ISM band may be at the millimeter-wave frequency such as the 60 GHz band to increase the channel bandwidth.

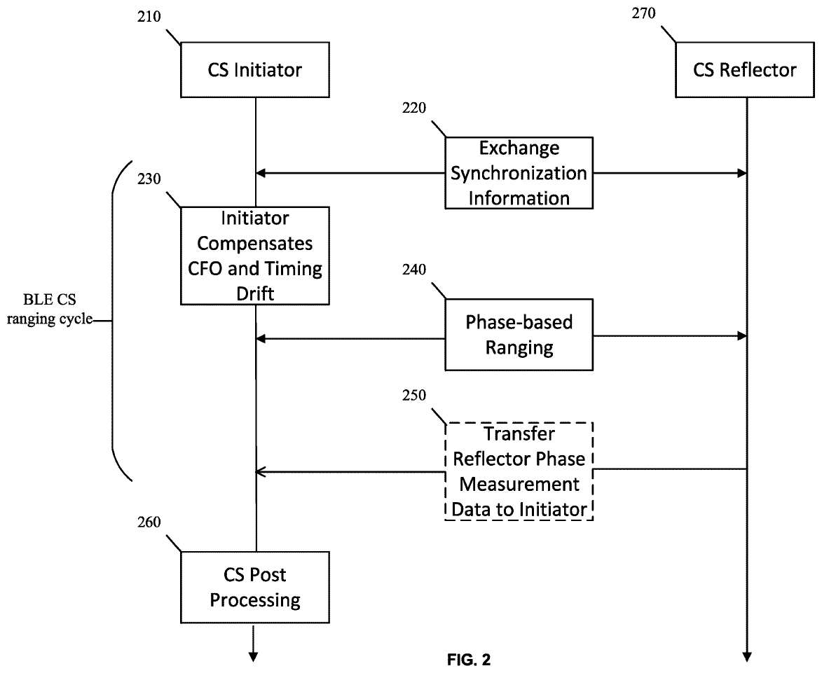

FIG. 2 is a signaling diagram illustrating an initiator device and a reflector device synchronizing timing and exchanging constant tone signals in Bluetooth LE CS application, and for the initiator device to process phase data measured by both devices to estimate a range between the devices, in accordance with one aspect of the present disclosure. A CS initiator 210 starts the BLE CS raging cycle with a CS reflector 270. The two devices exchanges constant tone signals over multiple channels to determine a wideband frequency domain transfer function of the channel.

Each ranging cycle may be divided into multiple timeslots. At the beginning of the BLE CS ranging cycle, in a calibration-synchronization timeslot, CS initiator 210 and CS reflector 270 may measure their frequency error offsets and may exchange synchronization information at operation 220 to synchronize their timing. CS initiator 210 may compensate for frequency offset and timing drift relative to CS reflector 270 at operation 230 based on the synchronization information. After the devices are time synchronized, a BT host may schedule the devices to perform the constant tone (CT) exchanges in subsequent timeslots. At the beginning of each subsequent timeslot, the devices may switch to a new channel that will be used for performing the CT exchanges in the timeslot. The CT exchanges on N channels using N respective timeslots may be designated as the phase-based ranging operation 240.

For example, at a first timeslot for the CT exchange, CS initiator 210 may transmit a CT signal to CS reflector 270 on a first channel f₁. CS reflector 270 may perform phase (or I/Q) measurement on the received CT signal. The phase measurement may depend on the distance between CS initiator 210 and the CS reflector 270, and the phase difference between the reflector's local oscillator (LO) used to receive the UP signal and the initiator's LO used to transmit the UP signal. CS reflector 270 may measure a phase of Φ_{Ref}. Following this, CS reflector 270 may transmit back a CT signal to CS initiator 210 on the same channel f₁ so that CS initiator 210 may perform its phase measurement. CS initiator 210 may measure a phase of Φ_{Ini} on its received CT signal. At the end of the ranging cycle following the N timeslots for CT exchanges, CS reflector 270 may transmit its measured phase Φ_{Ref} to initiator 210 at operation 250. CS initiator 210 initiator may sum its measured phase Φ_{Ini} with the phase Φ_{Ref} measured by CS reflector 270 to generate Φ₁, which may represent the phase difference experienced by the CT signal of channel f₁ after traversing twice the distance between CS initiator 210 and CS reflector 210. In one embodiment, CS initiator 210 and CS reflector 270 can measure the input signal phase of a received CT signal in hardware and can control the output signal phase of a transmitted CT signal, referred to as inline phase correction. In such cases, CS initiator 210 and CS reflector 270 can correct their phase ambiguity automatically in hardware because the phase ambiguity will be in multiples of 2π. As such, CS reflector 270 does not transmit its measured phase Φ_{Ref} to CS initiator 210 at operation 250. CS initiator 210 directly measures the I/Q of the received CT signal to estimate the range.

At a second timeslot, CS initiator 210 and CS reflector 270 may exchange CT signals on a second channel f₂. CS reflector 270 and CS initiator 210 may respectively measure a phase on the received CT signal on channel f₂. CS reflector 270 may transmit its measured phase to CS initiator 210 at operation 250 for CS initiator 210 to sum its measured phase with the phase measured by CS reflector 270 to generate Φ₂, which may represent the phase difference experienced by the CT signal of channel f₂ after traversing twice the distance between CS initiator 210 and CS reflector 270. Similarly, at a third timeslot, CS initiator 210 and CS reflector 270 may exchange CT signals on a third channel f₃. The resulting phase difference Φ₃ may represent the phase difference experienced by the CT signal of channel f₃ after traversing twice the distance between CS initiator 210 and CS reflector 270.

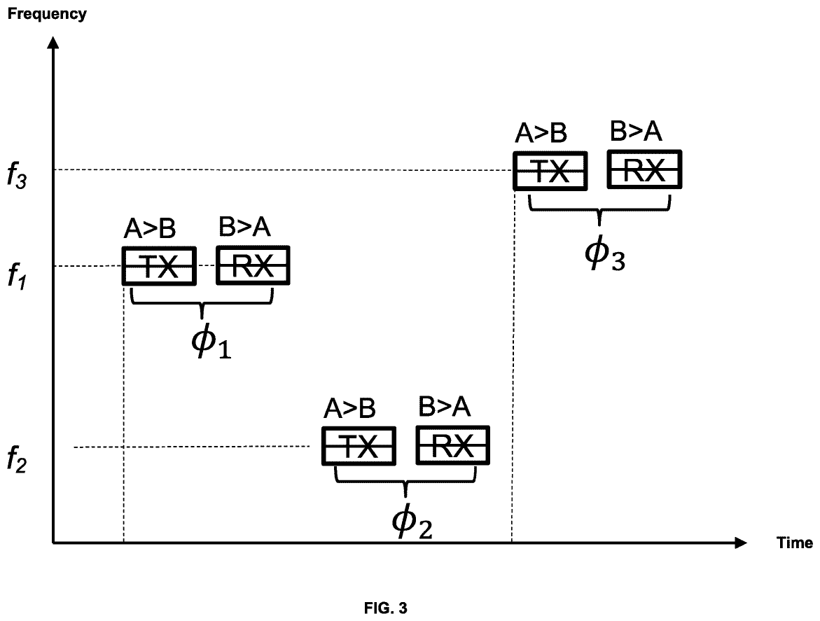

FIG. 3 illustrates two devices exchanging unmodulated pulse signals across multiple channels and measuring the phase shifts for the devices to estimate their mutual range, in accordance with one aspect of the present disclosure. Φ₁, Φ₂, and Φ₃ may represent the phase difference experienced by the CT signal of channel f₁, f₂, and f₃, respectively, after traversing twice the distance between CS initiator 210 and CS reflector 210.

Returning to FIG. 2, a CT signal on a channel k transmitted by CS initiator 210 and received by CS reflector 270 may be expressed as:

$$i {q}_{R}^{k} = {α}_{R}^{k} exp ( j ( - \frac{2 π {f}^{{k}_{D}}}{c} + {φ}_{1}^{k} - {φ}_{R}^{k} ) ) \qquad ( Equation 1 )$$

where

$$i {q}_{R}^{k}$$

the I/Q signal (in phase und quadrature components of complex envelope of the RF signal) measured by CS reflector 270 (e.g., phase of

$${iq}_{R}^{k}$$

is Φ_{Ref} above),
D is the distance between CS initiator 210 and the CS reflector 270;
c is the wave propagation speed;
f^{k} is the RF frequency of channel k;

$${φ}_{I}^{k}$$

is the phase ambiguity or CS initiator 210;

$${φ}_{R}^{k}$$

is un phase ambiguity of to reflector 270; and

$${α}_{R}^{k}$$

is the magnitude of

$$i {q}_{R}^{k} .$$

A CT signal transmitted by CS reflector 270 and received by CS initiator 210 on the same channel k may be expressed as:

$$i {q}_{I}^{k} = {α}_{I}^{k} exp ( j ( - \frac{2 π {f}^{{k}_{D}}}{c} + {φ}_{R}^{k} - {φ}_{I}^{k} ) ) \qquad ( Equation 2 )$$

where

$$i {q}_{I}^{k}$$

is the IQ signal measured by CS initiator 210 (e.g., phase of

$$i {q}_{I}^{k}$$

is Φ_{Ini} above); and

$${α}_{I}^{k}$$

is the magnitude of

$$i {q}_{I}^{k} .$$

CS initiator 210 may combine

$${q}_{R}^{k}$$

with

$$i {q}_{I}^{k}$$

to remove the phrase ambiguities:

$$i {q}^{k} = {β}^{k} i {q}_{I}^{k} * i {q}_{R}^{k} = exp ( j ( - \frac{4 π {f}^{{k}_{D}}}{c} ) ) \qquad ( Equation 3 )$$

where
iq^{k} represents the change in the CT signal on channel k after traversing twice the distance D between CS initiator 210 and the CS reflector 270; and
β^{k} is the magnitude of iq^{k}.

Equation 3 has a half-wave ambiguity. To resolve the half-wavelength ambiguity, the changes in the CT signal may be measured at two distinct frequencies:

$$Δφ [ k ] = \frac{4 π Δ f [ k ] D}{c} ( mod 2 π ) \qquad ( Equation 4 )$$

where
Δφ[k] is the change in phase between the two frequencies; and
Δf is the difference between the two frequencies.

A CS post processing operation 260 may estimate distance D using the IQ measurements (Δiq[k]) from a few frequencies:

$$D = - \frac{c Δ φ [ k ]}{4 π Δ f [ k ]} ( mod \frac{c}{2 Δ f [ k ]} ) \qquad ( Equation 5 )$$

Alternatively, CS post processing operation 260 may estimate distance D using the entire set of measurements from one ranging cycle, such as averaging over the changes in I/Q measured between pairs of frequencies over all the narrow channels in Bluetooth LE (e.g., K_{f}=72):

$$D = \frac{c}{4 π Δ f [ k ]} \frac{1}{{K}_{f} - 1} {\sum }_{k = 1}^{{K}_{f} - 1} Δφ [ k ] ( mod \frac{c}{2 Δ f} ) \qquad ( Equation 6 )$$

Thus, the bandwidth may be effectively increased by a factor of 72 without reducing the range ambiguity. As a result, the range estimate may be less sensitive to phase errors.

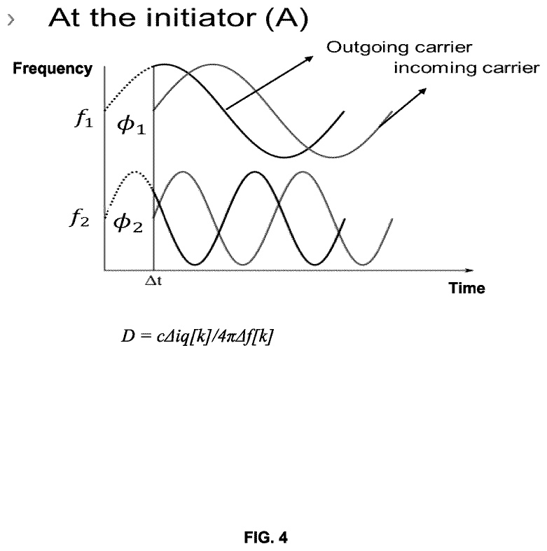

FIG. 4 illustrates CS initiator 210 estimating the distance to CS reflector 270 based on phases measured by CS initiator 210 and CS reflector 270 for two channels f¹ and f² in accordance with one aspect of the present disclosure.

Φ₁, and Φ₂ may represent the phase difference experienced by the CT signal of channel f¹ and f², respectively, after traversing twice the distance between CS initiator 210 and CS reflector 210. The distance D is estimated based on Equation 5 where Δiq[k] is the changes in I/Q between Φ₁, and Φ₂, and Δf[k] is the frequency difference between f¹ and f².

As mentioned, PBR applications using CT signals are prone to errors in an indoor or other dynamic changing environment due to target movement, changing signal propagation path, complex geometries, multipath, channel interference, etc. Disclosed is a technique for processing phase measurement data that improves the accuracy of PBR and tracking application in an dynamic indoor or other complex environment. The disclosed technique is able to learn patterns from vast amounts of phase measurement data, adapts to changing environments and reduces the need for repeated manual calibration. It includes anomaly detection to automatically handle out of distribution data to improve the accuracy of indoor location tracking. The technique uses BLE CS to illustrate its operation, but it may also be applied to other types of narrowband radios implementing PBR.

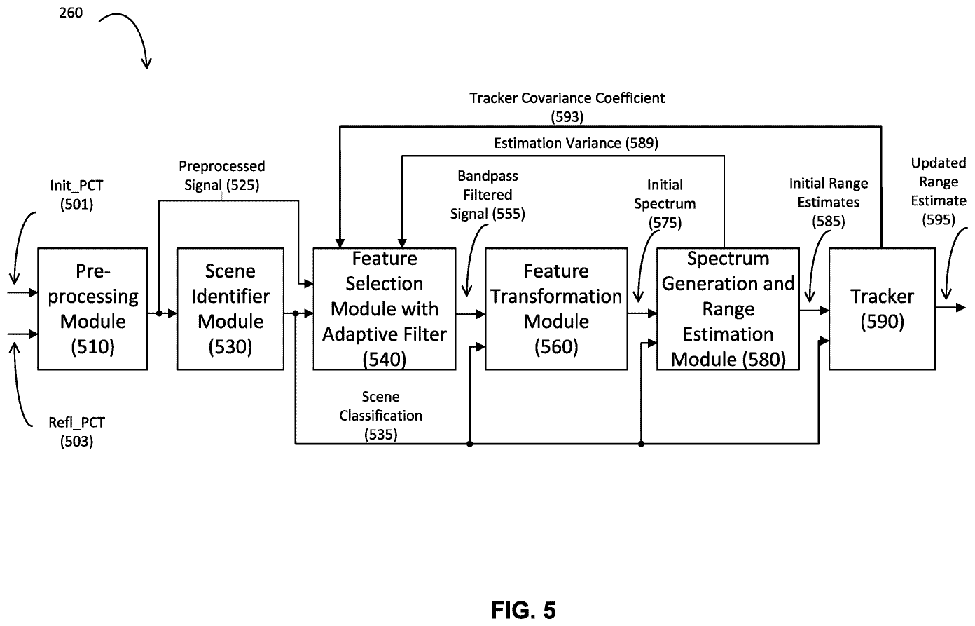

FIG. 5 illustrates a block diagram of a processing pipeline used by an initiator device of a phase-based ranging application to estimate the range to a reflector device, in accordance with one aspect of the present disclosure. The processing pipeline may be part of the CS post processing operation 260 of FIG. 2.

A preprocessing module 510 may preprocess I/Q data measured by the initiator and reflector during the CT exchanges on multiple channels to reduce artifacts introduced by the CT exchanges and other errors and/or interference in the data. The I/Q measurement data from the initiator and reflector may be designated Init_PCT 501 and_PCT 503, respectively. In one embodiment, the Init_PCT 501 and_PCT 503 may be divided into frames, with each frame representing the I/Q data measured over a ranging cycle of N timeslots for CT exchanges over N channels.

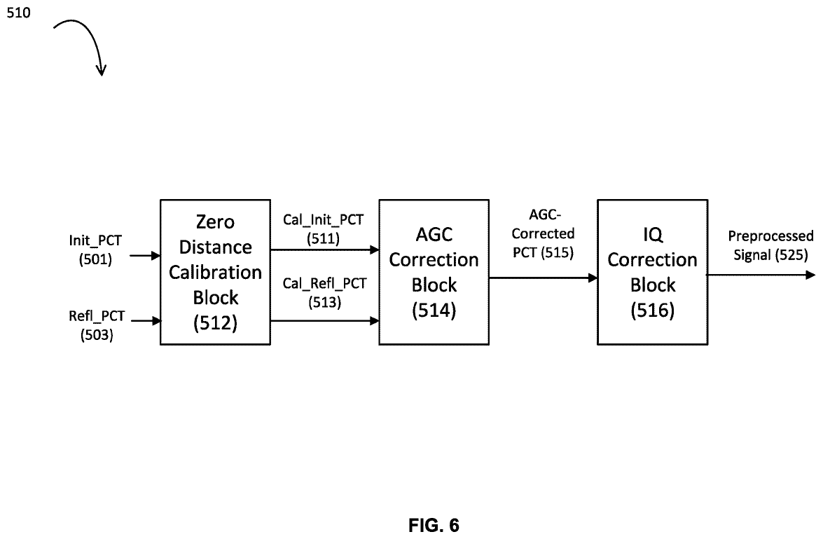

FIG. 6 illustrates a block diagram of a preprocessing module 510 used to remove errors and ambiguities in the I/Q measurement data prior to using the data for range estimation, in accordance with one aspect of the present disclosure. The preprocessing module 510 includes a zero distance calibration block 512, an AGC correction block 514, and an IQ correction block 516.

Zero distance calibration block 512 may be configured to process Init_PCT 501 and_PCT 503 to negate errors introduced by the antennas and any analog front-end (AFE) effects of the initiator and reflector. For example, errors in the measurement data due to antenna transfer function tolerance and device-to-device tolerance of the AFE of the initiator and reflector may be mitigated or reduced. In one embodiment, zero-distance calibration block 512 may perform calibration by putting initiator and reflector close to each other, such as in a clean environment (e.g., anechoic chamber) or in a multipoint setup when a clean environment is not available. I/Q measurement data generated during the calibration stage may be preprocessed, such as filtered, corrected for automatic gain control (AGC) changes, and denoised to obtain PCT calibration value.

During a PCT normalization stage, Init_PCT 501 and_PCT 503 from the CT exchanges may be normalized using the PCT calibration value. In one embodiment, the calibration stage may determine a bias that includes a distance offset and a phase offset. Init_PCT 501 and_PCT 503 from the CT exchanges may shift its respective I/Q by the phase offset to generate Cal_Init_PCT 511 and Cal_Refl_PCT 513, respectively. The processing pipeline may compensate for the distance offset by subtracting the distance offset from a an initial distance estimate when estimating the range.

AGC correction block 514 may correct for changes in the amplification of the CT signals when the initiator or reflector collects the I/Q data at different ranging cycles of the multi-channel CT exchanges. AGC correction block 514 may recalculate the magnitude of the PCT data measured by the initiator and reflector to compensate for the changes in the amplification so the processing pipeline may combine and process PCT data measured at different time for a channel.

In one embodiment, AGC correction block 514 may apply AGC correction to the Cal_Init_PCT 511 and Cal_Refl_PCT 513 to compensate for the AGC gain used to collect the I/Q measurement data by the following equations:

$$TableGainsMag = db 2 mag ( - TableGainDb ) \qquad ( Equation 7 )$$

$$Δ {iq}_{agc \_ corr}^{init} [ k ] = Δ i {q}^{init} [ k ] * T a b l e G a i n sMag ( Init\_Gain + 1 ) \qquad ( Equation 8 )$$

$$Δ {iq}_{agc \_ corr}^{r e f l} [ k ] = Δ i {q}^{r e f l} [ k ] * T a b l e G a i n s M a g ( Refl\_Gain + 1 ) \qquad ( Equation 9 )$$

where:
TableGainsMag is a function that converts an input gain from dB to magnitude;
Δiq^{init}[k] is the Cal_Init_PCT 511 for channel k;
Init_Gain is the AGC gain of the initiator when it performs the I/Q measurements at a particular timeslot for Init_PCT 501;

$$Δ {iq}_{agc \_ corr}^{init} [ k ]$$

is the Δiq^{init}[k] corrected for Init_Gain;
Δiq^{refl}[k] is the Cal_Refl_PCT 513 for channel k;
Refl_Gain is the AGC gain of the reflector when it performs the I/Q measurements at a particular timeslot for Refl_PCT 503; and

$$Δ i {q}_{agc \_ corr}^{r e f l} [ k ]$$

is the Δiq^{refl}[k] corrected for Refl_Gain.

In another embodiment, AGC correction block 514 may apply AGC correction to the Cal_Init_PCT 511 and Cal_Refl_PCT 513 to compensate for the AGC gain used to collect the I/Q measurement data by the following equations:

$$Δ {iq}_{agc \_ corr}^{init} [ k ] = Δ {iq}^{init} [ k ] * {\sqrt{2}}^{( - Init \_ Gain )} \qquad ( Equation 10 )$$

$$Δ {iq}_{agc \_ corr}^{refl} [ k ] = Δ {iq}^{refl} [ k ] * {\sqrt{2}}^{( - {Refl}_{Gain} )} \qquad ( Equation 11 )$$

In another embodiment, AGC correction block 514 may apply AGC correction to the combined PCT derived from calibrated initiator PCT 511 and calibrated reflector PCT 513 by the following equations:

$$Δ i q [ k ] = Δ {iq}^{init} [ k ] * Δ {iq}^{r e f l} [ k ] \qquad ( Equation 12 )$$

$$Δ {iq}_{agc \_ corr} [ k ] = Δ i q [ k ] * {\sqrt{2}}^{( - Init \_ Gain - Refl \_ Gain )} \qquad ( Equation 13 )$$

where
Δiq[k] is the combined Δiq^{init}[k] and Δiq^{refl}[k] (also referred to as residual PCT or Res-PCT) for channel k (see Equation 4); and
Δiq_{agc_corr}[k] is the Δiq[k] corrected for Init_Gain and Refl_Gain.

In one embodiment, AGC correction block 514 may apply AGC correction to thresholds and weights used for combining and processing the I/Q measurement data over the different ranging cycles of the multi-channel CT exchanges. For example, a measurement verification component of the AGC correction block 514 may compare the sum of the power of the combined PCT (e.g., Res_PCT) for a channel against a threshold to identify and exclude from further processing any outlier data. If the sum of the power of the combined PCT for a channel is less than the threshold, the combined PCT for the channel is ignored. AGC correction block 514 may generate AGC-corrected PCT 515 as an output.

An IQ correction block 516 may correct for phase ambiguity in the I/Q measurement data due to Doppler frequency, co-channel interference, and two-sided communication of the CT exchanges. IQ correction block 516 may operate on the AGC-corrected PCT 515 received from AGC correction block 514 or other I/Q measurements in the processing pipeline. IQ correction block 516 may generate preprocessed signal 525 as an output of the preprocessing module 510.

In one embodiment, IQ correction block 516 may reduce distance error due to phase ambiguity because the PCT data with respect to a moving target are not measured at the same time for all channels. A velocity correction sub-block may compensate for the phase offset due to target motion by:

$$Δ {iq}_{vel \_ corr} [ k ] = Δ iq [ k ] * {e}^{j * vel \_ comp} \qquad ( Equation 14 )$$

$$vel\_comp = 2 π * f * ( t 1 - t 2 ) * v / c \qquad ( Equation 15 )$$

where
Δiq[k] may be the Res_PCT for channel k or the AGC-corrected PCT 515 for channel k;
Δiq_{vel_corr}[k] is Δiq[k] corrected for the phase offset due to target motion;
vel_comp is the phase offset:
f is the frequency of the CT signal for channel k;
(t1−t2) is the delay between PCT measurements;
t1 is the start measurement time (e.g., of the ranging cycle)
t2 is the PCT measurement time at frequency f; and
v is the Doppler velocity between the initiator and reflector.

In one embodiment, IQ correction block 516 may reduce or cancel co-channel interference such as Wi-Fi interference. A channel interference cancellation sub-block may measure a quality factor of the I/Q measurement data to identify any interference signal. In one embodiment, the channel interference cancellation sub-block may identify an interference signal when the magnitude of Res_PCT is greater than an interference threshold. The channel interference cancellation sub-block may correct for the interference signal by weighting Res_PCT as a function of the quality factor or interpolating the I/Q measurement data in the frequency or time domain using techniques such as linear interpolation, cubic interpolation, or through neural networks.

In one embodiment, IQ correction block 516 may filter the I/Q measurement data using a low pass filter to reduce side lobes and noise. The bandwidth or order of the low pass filter may be tunable. The low pass filter may smooth the Res_PCT to remove strong multipath signal that is too far away.

In one embodiment, IQ correction block 516 may remove ghost lobes that appear due to two-sided communication between the initiator and reflector and are combinations of true lobes. A ghost lobes removal sub-block may determine a square root of Res_PCT. The ghost lobes removal sub-block may recover true lobes from ambiguity in the I/Q measurement data by:

$$s 1 = \vert \sqrt{Δ iq [ idx ]} - \sqrt{Δ iq [ idx - 1 ]} \vert \qquad ( Equation 16 )$$

$$s 2 = \vert \sqrt{Δ iq [ idx ]} * {e}^{j * π} - \sqrt{Δ iq [ idx - 1 ]} \vert \qquad ( Equation 17 )$$

$$\begin{matrix}S = min ( s 1 , s 2 ) \\ iq [ idx ] = \{ \begin{matrix}Δ iq [ idx ] if S = s 1 \\ Δ iq [ idx ] * {e}^{j * π} if S = s 2\end{matrix}\end{matrix} \qquad ( Equation 18 )$$

### Where

Δiq[idx] is the Res_PCT of the current ranging cycle or frame; and
Δiq[idx−1] is the Res_PCT of the previous ranging cycle or frame.

Returning to FIG. 5, a scene identification module 530 may process statistical properties of the preprocessed signal 525 to identify the scene (e.g., indoor with dynamic variation, indoor with low variation, outdoor, etc.). The identified scene may be used to set the processing pipeline. For example, algorithmic parameters of the processing pipeline may be tuned or optimized based on the identified scene to improve the accuracy of PBR in an indoor environment.

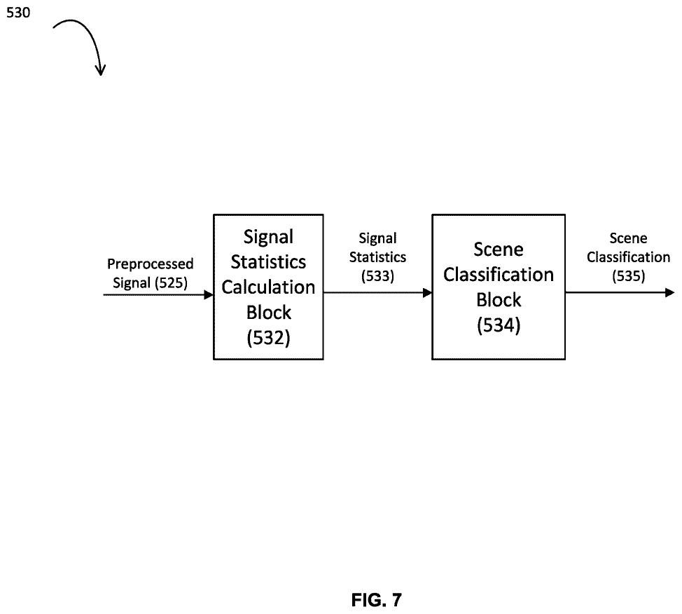

FIG. 7 illustrates a block diagram of a scene identifier module 530 used to calculate statistics of the I/Q measurement data and to identify the scene of the operating environment, in accordance with one aspect of the present disclosure. Scene identifier module 530 may include a signal statistics calculation block 532 and a scene classification block 534.

Signal statistics calculation block 532 may calculate local statistical properties of the preprocessed signal 525 (e.g., preprocessed Res_PCT) received from preprocessing module 510. In one embodiment, signal statistics calculation block 532 may fit a first order polynomial to the preprocessed data 525 of a ranging cycle to calculate a mean square error (MSE). The first order polynomial may approximate a slope of the distribution of the I/Q measurements across the multiple channels of the ranging cycle. The MSE may capture the variability of the I/Q measurements around the slope. In one embodiment, signal statistics calculation block 532 may calculate the mean of the magnitude of preprocessed data 525 within a window to capture the average magnitude of the I/Q measurements (or average distance value in the time domain) within the window. The window may span across one or multiple channels of a ranging cycle. In one embodiment, signal statistics calculation block 532 may calculate the standard deviation of the magnitude of preprocessed data 525 within a window to capture the variability of the magnitude of the I/Q measurements around the mean within the window.

In one aspect, signal statistics calculation block 532 may calculate global statistical properties of the preprocessed data 525 based on the local statistics. In one embodiment, signal statistics calculation block 532 may calculate the mean and/or the standard deviation of the MSE across multiple ranging cycles. In one embodiment, signal statistics calculation blocks 532 may calculate the mean of the local means across windows to determine a global average magnitude of the I/Q measurements. In one embodiment, signal statistical calculation block 532 may calculate the standard deviation of the local means across windows to determine a global variability of the local means. In one embodiment, signal statistical calculation block 532 may calculate a mean of the local standard deviations to determine a global average of the standard deviation of the magnitude of the I/Q measurements. The local statistical properties and/or the global statistical properties may be output as signal statistics 533.

Scene classification block 534 may define or characterize thresholds to be compared against the signal statistics 533 based on empirical observations or domain knowledge of the statistical properties associated with different scene types (i.e., indoor vs. outdoor scene). In one embodiment, there may be multiple thresholds associated with different scene categories. For example, an indoor scene with dynamic variation may be associated with defined thresholds for one or more of MSE, local mean, local standard deviation, mean of MSE, standard deviation of MSE, mean of local means, standard deviation of local means, mean of local standard deviation, etc. Scene classification block 534 may analyze signal statistics 533 and compare them to the defined thresholds. An indoor scene with low variation or an outdoor scene may have a different set of defined thresholds. Based on which thresholds are crossed, scene classification block 534 may classify the scene into a category for output as scene classification 535. Scene classification 535 may be used to tune parameters or select algorithm in the signal processing pipeline.

Returning to FIG. 5, a feature selection module with adaptive filter 540 may adaptively adjust a bandwidth of a bandpass filter used to filter preprocessed signal 525 based on a level of confidence associated with the data points and scene classification 535. For example, when scene classification 535 indicates an indoor scene, the bandwidth of the bandpass filter may be modulated by a confidence estimate of the data points. In one embodiment, the confidence estimate may be based on the signal-to-noise ratio (SNR) of the data points. A higher SNR may indicate higher confidence in the data points. In one embodiment, the confidence estimate may be uncertainty in the measurement techniques such as a tracker covariance coefficient 593 from a tracker module 590. In one embodiment, tracker covariance coefficient 593 may be the covariance matrix representing uncertainty in the state estimate from a Kalman filter. Higher values in the elements of the covariance matrix may indicate lower confidence in the range estimate. In one embodiment, the confidence estimate may be other variability measure of the data points such as the MSE, local standard deviation, standard deviation of local means, mean of local standard deviation, etc., calculated by scene identifier module 530. In one embodiment, the confidence estimate may be an estimation variance 589 of range estimates from a spectrum generation and range estimation module 580.

The confidence-based bandpass filter may allow frequency components within a desired range to pass through while attending other. For example, for data points with high confidence, the bandpass filter operates with a narrower bandwidth to allow a smaller range of frequencies around the expected signal to pass through. The narrower bandwidth focuses on the most likely signal components and reduces the influence of out-of-band interference, reflections, or noise to improve the accuracy of the estimated range as confidence increases. For data points with low confidence, the bandpass filter operates with a wider bandwidth to reduce the influence of potentially unreliable filtering on the final estimates. The wider bandwidth captures a potential change in the true signal (e.g., target moved) to prevent the filter from attenuating the new desired signal components.

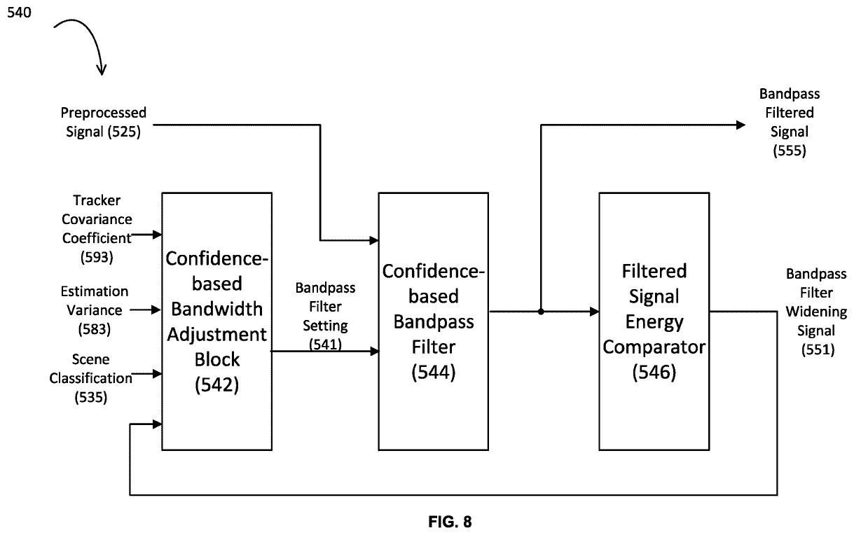

FIG. 8 illustrates a block diagram of a feature selection module with adaptive filter 540 used to adaptively adjust a bandwidth of a confidence-based bandpass filter for filtering the I/Q measurement data based on a confidence level in the data points and the identified scene, in accordance with one aspect of the present disclosure. Feature selection module with adaptive filter 540 may include a confidence-based bandwidth adjustment block 542, a confidence-based bandpass filter 544, and a filtered signal energy comparator 546.

Confidence-based bandwidth adjustment block 542 may adjust the bandwidth of the passband filter based on tracker covariance coefficient 593 when scene classification 535 indicates an indoor scene. The tracker covariance coefficient 593 may be a covariance matrix generated by a tracker module 590, such as a Kalman filter. The Kalman filter processes measurement data to provide an estimate of the range (e.g., target distance) and its associated covariance. The covariance matrix may represent the uncertainty in the estimate of the Kalman filter based on the data points. A smaller covariance indicates higher confidence in the estimate and may be the result of more measurement data giving rise to the same range estimate. Confidence-based bandwidth adjustment block 542 may gradually narrow the filter bandwidth (e.g., stop frequencies) closer to the ideal or original design values. The narrower bandwidth allows a smaller range of frequency components around the expected signal to pass through. The bandpass filter thus focuses on the most likely signal components and reduces the influence of out-of-band interference, reflections, or noise on the data points. In one embodiment, adjusting the stop frequencies based on tracker covariance coefficient 593 may involve pre-defined relationship or dynamic calculations.

However, the filter bandwidth may not shrink beyond a minimum frequency limit (e.g., 0.2 m in range equivalent around the expected signal). In one embodiment, the minimum frequency limit may be set based on the refresh rate of the estimate provided by the Kalman filter and a maximum speed of initiator and reflector movement. The minimum frequency limit allows the center frequency of the bandpass filter to be adjusted in either direction (target moving closer or away) due to movement of the initiator and reflector.

Confidence-based bandwidth adjustment block 542 may provide bandpass filter setting 541 to confidence-based bandpass filter 544. Confidence-based bandpass filter 544 may filter preprocessed signal 525 (e.g., preprocessed Res_PCT) based on bandpass filter setting 541 to generate bandpass filtered signal 555.

In one embodiment, a threshold is set for the energy of bandpass filtered signal 555. Filtered signal energy comparator 546 may calculate the energy of bandpass filtered signal 555 and compare the filtered energy against the threshold. If the filtered energy falls below the threshold, it may indicate a potential change in the true signal, for example when the target moved. In this case, filtered signal energy comparator 546 may generate a bandpass filter widening signal 551 to indicate confidence-based bandwidth adjustment block 542 to widen the bandwidth. The broader frequency range allows confidence-based bandpass filter 544 to capture potentially changing signal and mitigating the influence of potentially unreliable data. The threshold-based bandwidth widening allows confidence-based bandpass filter 544 to adapt to changes in the true signal, preventing excessive filtering when the target moves. In one embodiment, the threshold for the bandpass filtered signal 555 may be determined based on the application and noise characteristics.

In one embodiment, confidence-based bandwidth adjustment block 542 may adjust the bandwidth of confidence-based bandpass filter 544 based on estimation variance 589 of range estimates when scene classification 535 indicates an indoor scene. In one embodiment, a spectrum generation and range estimation module 580 of the processing pipeline may estimate a current estimation variance 589 based on the range estimate derived from the current frame or ranging cycle of data. Confidence-based bandwidth adjustment block 542 may compare the current estimation variance 589 with previous estimation variance based on the range estimate derived from one or more previous frames of data. If the current estimation variance 589 is decreasing from the previous estimation variance, there is higher confidence in the range estimate. It may also signify a more stable and consistent signal. In this case, confidence-based bandwidth adjustment block 542 may narrow the filter bandwidth to allow a more precise selection of signal frequency components to pass through.

Otherwise, if the current estimation variance 589 is increasing from the previous estimation variance, there is less confidence in the range estimate. If the filtered energy of bandpass filtered signal 555 is also below the above-described filtered energy threshold, indicating a potential change in the true signal (e.g., target moved), confidence-based bandwidth adjustment block 542 may increase its bandwidth to capture the potentially changing signal components and mitigate the influence of potentially unreliable data.

Returning to FIG. 5, a feature transformation module 560 may implement a minimum variance distortion-less response (MVDR) algorithm to transform bandpass filtered signal 555 from the frequency domain to the time domain as a function of the identified scene. The MVDR algorithm is an adaptive beamforming technique that seeks to minimize the output power from an antenna array while maintaining a unity gain toward a desired signal direction defined by a steering vector. Feature transformation module 560 applies the MVDR beamforming algorithm to the domain of range estimation to find the spectrum with the dominant frequency at a desired range defined by a steering vector. The MVDR-based technique generates a narrower peak in the time domain than an IFFT-based technique, allowing finer resolution of multipath components to detect the target as the closest peak.

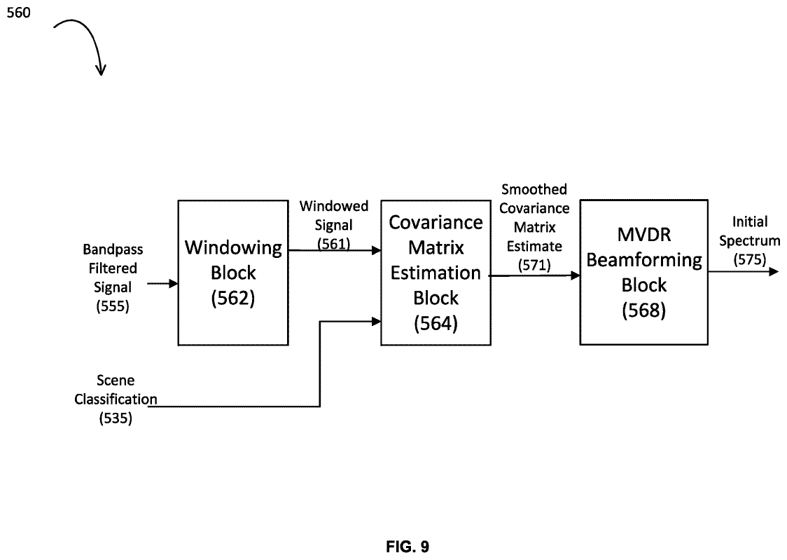

FIG. 9 illustrates a block diagram of a feature transformation module 560 of the processing pipeline implementing a MVDR algorithm to transform the bandpass filtered I/Q measurement data from the frequency domain to the time domain as a function of the identified scene, in accordance with one aspect of the present disclosure. Feature transformation module 560 may include a windowing block 562, a covariance matrix estimation block 564, and a MVDR beamforming block 568.

Window block 562 may apply a window function to bandpass filtered signal 555 to reduce spectral leakage such as to eliminate sidelobes. In one embodiment, the window function may be a Hann window based on the operation:

$$w ( n ) = 0.5 * ( 1 - cos ( 2 π n / ( M - 1 ) ) ) for n = 0 , 1 , … , ( M - 1 ) \qquad ( Equation 19 )$$

$$Δ {iq}_{w} [ n ] = Δ iq [ n ] * w ( n ) \qquad ( Equation 20 )$$

where
w(n) is the Hann window function;
Δiq[n] is the bandpass filtered signal 555 (e.g., bandpass filtered Res_PCT) for a channel; and
Δiq_{w}[n] is the output windowed signal 561.

Covariance matrix estimation block 564 may construct the covariance matrix of windowed signal 561 using the operation:

$${R}_{xx ( n )} = α * {R}_{xx ( n - 1 )} + ( 1 - α ) * \frac{1}{( N - M + 1 )} {\sum }_{i = 1}^{N - M + 1} Δ {iq}_{w} ( i : i + M - 1 ) Δ {{iq}_{w} ( i : i + M - 1 )}^{H} \qquad ( Equation 21 )$$

where
Δiq_{w}(i:i+M−1)Δiq_{w}(i:i+M−1)^{H} is the covariance matrix of Δiq_{w}[n];
Rₓₓ₍ₙ₎ is the smoothed covariance matrix of Δiq_{w}[n] (e.g., based on current frame of I/Q data);
Rₓₓ₍ₙ₋₁₎ is the smoothed covariance matrix of Δiq_{w}[n] (e.g., based on previous frame of I/Q data);
α is a temporal smoothing factor;
N is the number of frequency channels;
M is the dimension of the covariance matrix Rₓₓ where M<N; and
H is the Hermitian transpose operation.

Equation 21 shows that the covariance matrix is temporally smoothed using the temporal smoothing factor α. The lower the α, the more emphasis is placed on the current covariance matrix of x_{w}(n) and less emphasis on the older covariance matrix. In one embodiment, Rₓₓ₍ₙ₎ (or simply Rₓₓ) may be an average of the covariance matrix over time. In one embodiment, temporal smoothing of the covariance matrix may be implemented in two passes in a forward-backward manner. In a first pass, temporal smoothing may be implemented using a forward-looking version of the I/Q measurement data such as based on equation 21. In a second pass, temporal smoothing may be implemented using the time-reversed (backward) version of the same I/Q measurement data.

Equation 21 shows that the covariance matrix is also spatially smoothed based on:

$$\frac{1}{( N - M + 1 )} {\sum }_{i = 1}^{N - M + 1} Δ {iq}_{w} ( i : i + M - 1 ) Δ {{iq}_{w} ( i : i + M - 1 )}^{H} \qquad ( Equation 22 )$$

Spatial smoothing spatially averages the M×M covariance matrix over the range of N frequency channels. In one embodiment, M is a function of the scene. For example, M may be higher if scene classification 535 indicates an indoor scene compared to an outdoor scene (e.g., M=42 if scene classification 535 indicates an indoor scene; and M=16 for an outdoor scene).

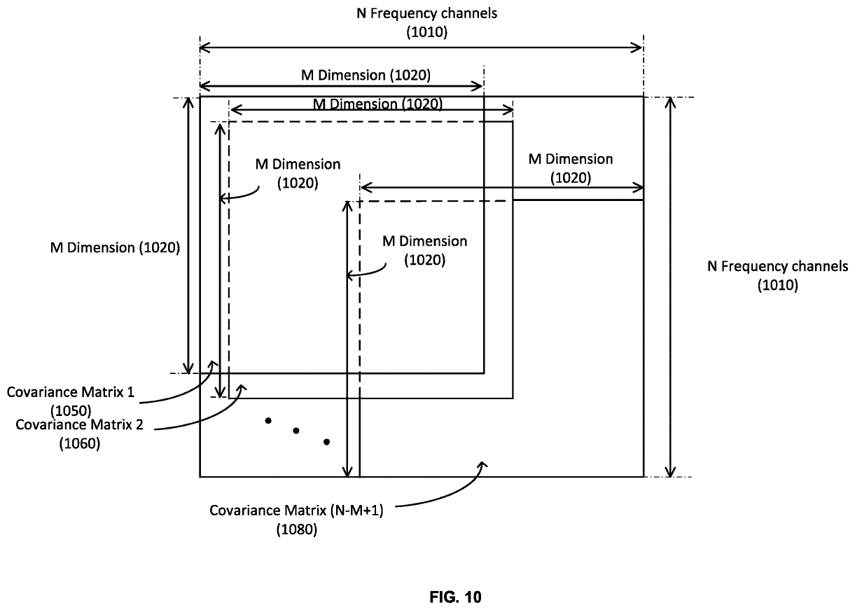

FIG. 10 illustrates spatial smoothing of the covariance matrix of the bandpass filtered I/Q measurement data using the MVDR transformation, in accordance with one aspect of the present disclosure. The dimension M (1020) of a covariance matrix is less than the N frequency channels (1010). Covariance matrix 1 (1050) may be x_{w}(1:M)x_{w}(1:M)^{H}; covariance matrix 2 (1060) may be x_{w}(2:M+1)x_{w}(2:M+1)^{H} . . . and covariance matrix (N−M+1) (1080) may be x_{w}(N−M+1:N)x_{w}(N−M+1:N)^{H}. Each covariance matrix is spatially offset by one frequency channel from the nearest covariance matrix. As shown, there are (N−M+1) covariance matrices to cover the range of N frequency channels (1010).

Returning to FIG. 9, MVDR beamforming block 568 may calculate an initial spectrum 575 of the bandpass filtered signal 555 based on the smoothed covariance matrix estimate 571 and a steering vector. MVDR beamforming block 568 may attempt to minimize the power of initial spectrum 575 while determining the dominant frequency in a range defined by the steering vector.

In one embodiment, the steering vector may be expressed as:

$$w ( θ ) = [ 1 , {e}^{- j 2 πθΔ f} , {e}^{- j 2 πθ ( 2 * Δ f )} , {e}^{- j 2 πθ ( ( N - 1 ) * Δ f )} ] \qquad ( Equation 23 )$$

where
w(θ) is the steering vector for the desired range θ;
N is the number of frequency channels; and
Δf is the width of each frequency channel.

MVDR beamforming block 568 may calculate the MVDR output at the range θ∈[0, Rₘₐₓ] based on:

$$P ( θ ) = \frac{{w}^{H} ( θ ) w ( θ )}{{w}^{H} ( θ ) {R}_{xx}^{- 1} w ( θ )} \qquad ( Equation 24 )$$

where
Rₘₐₓ is the maximum range;
P(θ) is the MVDR output;
w(θ) is the steering vector of Equation 23; and

$${R}_{xx}^{- 1}$$

is the inverse of Rₓₓ₍ₙ₎ of equation 21.
   MVDR beamforming block 568 may output P(θ) as initial spectrum 575.

Returning to FIG. 5, a spectrum generation and range estimation module 580 may process initial spectrum 575 generated by the MVDR transformation to generate parallel moving average spectrum for range estimation and faster Kalman filter estimate convergence. Multiple moving average spectrums, each one with a different smoothing factor, may generate smoothed spectral trend for range estimation. The smoothing factors may be adaptive to the identified scene, so a moving average spectrum may adapt faster to changes in the spectral trend for an indoor scene with dynamic variation. A range estimation algorithm may operate on each of the multiple moving average spectrum to estimate the respective range as a corresponding closest peak (e.g., earliest peak). The range estimation algorithm may also be adaptive to the identified scene.

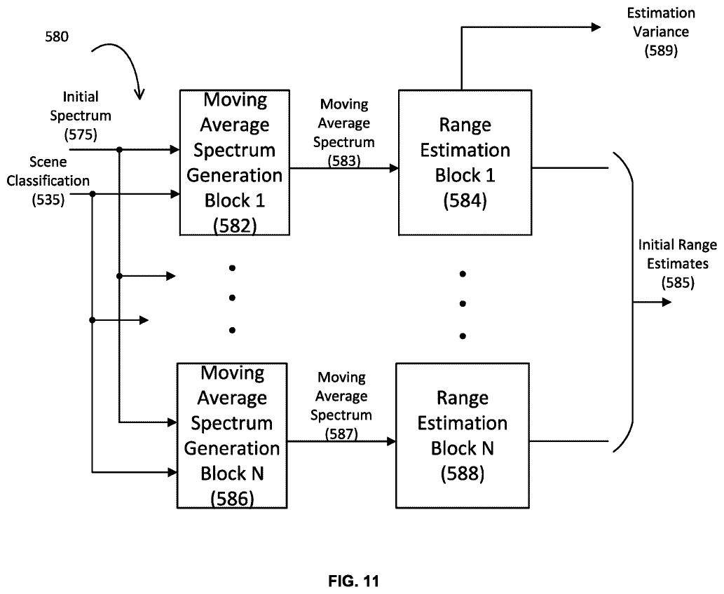

FIG. 11 illustrates a block diagram of a spectrum generation and range estimation module 580 used to oversample the time-domain data to generate parallel initial range estimates as a function of the identified scene, in accordance with one aspect of the present disclosure. Spectrum generation and range estimation module 580 may include N parallel moving average spectrum generation blocks 1 (582) . . . . N (586) and corresponding N parallel range estimation blocks 1 (584) . . . . N (588).

Each moving average spectrum generation block (582 . . . 586) may generate a corresponding moving average spectrum (583 . . . 587) to represent a smoothed spectral trend of initial spectrum 575 using a corresponding one of N smoothing factors (α₁, α₂ . . . α_{N}). The moving average spectrum Sₘ(θ) may be initialized as:

$${S}_{0} ( θ ) = {P}_{0} ( θ ) \qquad ( Equation 25 )$$

where
S₀(θ) is the initial moving average spectrum at time step 0; and
P₀(θ) is the P(θ) of Equation 24 (initial spectrum 575) at time step 0.

At each new time step t, each moving average spectrum generation block (582 . . . 586) may update its moving average spectrum Sₘ(θ) based on the current spectrum P(θ). The updating of the moving average spectrum Sₘ(θ) may be expressed as:

$${S}_{t}^{i} ( θ ) = {α}_{i} {P}_{t} ( θ ) + ( 1 - {α}_{i} ) {S}_{t - 1}^{i} ( θ ) \qquad ( Equation 26 )$$

where

$${S}_{t}^{i} ( θ )$$

is the moving average spectrum Sₘ(θ) at time step t for moving average spectrum generation block i;
αᵢ is the smoothing factor for moving average spectrum generation block i;
Pₜ(θ) is the P(θ) at time step t; and

$${S}_{t - 1}^{i} ( θ )$$

is the moving average spectrum Sₘ(θ) at time step (t−1) for moving average spectrum generation block i.

In one embodiment, the smoothing factor αᵢ may be adaptively determined based on the scene type (scene classification 535). A higher αᵢ gives more weight to the current spectrum Pₜ(θ), resulting in a faster adaptation of the moving average spectrum. For example, an indoor scene with dynamic variation may configure a αᵢ≈1. Conversely, a lower αᵢ gives more weight to past spectrum (e.g., previous moving average spectrum

$${S}_{t - 1}^{i} ( θ ) ) ,$$

leading to a slower adaptation of the moving average spectrum. In one embodiment, the N smoothing factors (α₁, α₂ . . . α_{N}) for the N parallel moving average spectrum generation blocks 1 (582) . . . . N (586) may be different. The moving average spectrum

$${S}_{t}^{i} ( θ )$$

represents the smoothed spectral trend of P(θ) at time step t for moving average spectrum generation block i.

The N parallel range estimation blocks 1 (584) . . . . N (588) may calculate initial range estimates 585 based on the N corresponding moving average spectrum

$${S}_{t}^{i} ( θ )$$

(moving average spectrum (583 . . . 587)). In one embodiment, each range estimation block may initialize an empty list of candidate peaks for storing range indices of candidate time-domain peaks. A range index for a candidate peak may represent an estimated range of the candidate peak. Each range estimation block may loop through its moving average spectrum

$${S}_{t}^{i} ( θ )$$

more candidate peaks. If the a point on the moving average spectrum

$${S}_{t}^{i} ( θ )$$

is greater than its neighbors on the left and on the right, and the point is greater than a predefined threshold, a range estimation block may add the range index of the point as an candidate peak to its list.

After a loop through the moving average spectrum

$${S}_{t}^{i} ( θ ) ,$$

the list of candidate peaks may store the range indices for one or more candidate peaks. The candidate peaks may represent signal peaks of a direct path component or multipath components. A range estimation block may select the range index for a first element in its list of candidate peaks (e.g., a candidate peak with the smallest range index representing the direct path component) as the current closest peak index. The range estimation block may determine if the current closest peak index is greater than a specific range. In one embodiment, the specific range may be set at 3 m. In one embodiment, if the current closest peak index is greater than the specific range and if scene classification 535 indicates an indoor scene, the range estimation block may use the current closest peak index to find the range index of a point 1.5 dB down to the left (closer in range) of the candidate peak corresponding to the current closest peak index. The range estimation block may update the current closest peak index with this newly found range index. The range estimation block may report the current closest peak index as its initial range estimate (585). The N parallel range estimation blocks 1 (584) . . . . N (588) may report N initial range estimates 585 based on the N corresponding moving average spectrum

$${S}_{t}^{i} ( θ ) .$$

In one embodiment, the N parallel range estimation blocks 1 (584) . . . . N (588) may update N initial range estimates 585 for every frame (e.g., ranging cycle) of I/Q measurement data. In one embodiment, one of the range estimation blocks (e.g., range estimation block 1 (584)) may determine a variance of its reported initial range estimates 585 from the multiple frames of I/Q measurement data. The variance of initial range estimate 585 may be output as estimation variance 589. In one embodiment, estimation variance 589 may be determined based on a variance of initial range estimates 585 reported by the N parallel range estimation blocks 1 (584) . . . . N (588). As discussed, feature selection module with adaptive filter 540 may use estimation variance 589 as a measure of the level confidence associated with the I/Q measurement data to adjust the bandwidth of the confidence-based bandpass filter.

Returning to FIG. 5, a tracker module 590 may be a Kalman filter that processes N initial range estimates 585 from N parallel range estimation blocks 1 (584) . . . . N (588) of spectrum generation and range estimation module 580 to achieve faster convergence of the range estimates. The Kalman filter may output the state covariance matrix as tracker covariance coefficient 593 to represent the uncertainty in the state estimate. As discussed, tracker covariance coefficient 593 may provide the confidence level feedback for the confidence-based bandpass filter to adjust its bandwidth.

The Kalman filter for range estimates may have a state vector x containing two or three elements. A state vector containing two elements may be represented as:

$$= {[ h \dot{h} ]}^{T} \qquad ( Equation 27 )$$

A state vector containing three elements may be expressed as:

$$x = {[ h \dot{h} \ddot{h} ]}^{T} \qquad ( Equation 28 )$$

where
x is the state vector;
h is the target position (range value);
\dot{h} is the target velocity; and
\ddot{h} is the target acceleration;

The state vector with two elements may assume a constant velocity model to describe how the state evolves over time. The constant velocity model may be represented by the state transition matrix A:

$$A = [ \begin{matrix}1 & Δ t \\ 0 & 1\end{matrix} ] \qquad ( Equation 29 )$$

where
Δt is the time step between measurements (e.g., time step between initial range estimates (585))

The state vector with three elements may assume a constant acceleration model to describe how the state evolves over time. The constant acceleration model may be represented by the state transition matrix A:

$$A = [ \begin{matrix}1 & Δ t & 0.5 Δ {t}^{2} \\ 0 & 0 & Δ t \\ 0 & 0 & 1\end{matrix} ] \qquad ( Equation 30 )$$

The Kalman filter may predict the current state vector \hat{x}ₖ based on the estimated state vector xₖ₋₁ for the previous state and the state transition matrix A before receiving a new measurement:

$${\hat{x}}_{k} = {Ax}_{k - 1} \qquad ( Equation 31 )$$

where
\hat{x}ₖ is the current predicted state vector; and
xₖ₋₁ is the previous estimated state vector.

The Kalman filter may estimate a covariance matrix Pₖ₋₁ to represent the uncertainty in the previous state estimate xₖ₋₁. Kalman filter may propagate estimated covariance matrix Pₖ₋₁ to predict the covariance matrix \hat{P}ₖ for the current state estimate xₖ based on:

$${\hat{P}}_{k} = {AP}_{k - 1} {A}^{H} + Q \qquad ( Equation 32 )$$

where
\hat{P}ₖ is the current predicted covariance matrix;
Pₖ₋₁ is the previous estimated covariance matrix; and
Q is a process noise covariance matrix that accounts for the uncertainty in the state transition model.

The Kalman filter may predict the target position based on the current state Ak and a measurement matrix H based on:

$${\hat{y}}_{k} = H {\hat{x}}_{k} \qquad ( Equation 33 )$$

where
ŷₖ is the predicted target position; and

H is the measurement matrix, which may be [1 0] for a state vector with two elements, or may be [1 00] for a state vector with three elements, indicating that the target position may be directly measured.

When a new measurement (e.g., initial range estimate 585) is received, the Kalman filter may calculate the difference between the new measurement and the predicted target position, also referred to as the innovation, based on:

$${v}_{k} = {z}_{k} - {\hat{y}}_{k} \qquad ( Equation 34 )$$

where
vₖ is the difference (innovation); and
zₖ is the new range measurement.

The Kalman filter may also update its state when a new measurement is received. For example, the Kalman filter may update a Kalman gain Kₖ to determine how much weight to give to the new measurement relative to the predicted state based on:

$${K}_{k} = {\hat{P}}_{k} {{H}^{H} ( H {\hat{P}}_{k} {H}^{H} + R )}^{- 1} \qquad ( Equation 35 )$$

where
\hat{P}ₖ is the predicted covariance matrix for the current state (Equation 32)
H is the measurement matrix; and
R is the measurement noise covariance matrix representing the uncertainty in the measurements.

The Kalman filter may update an estimate of the state vector with the new measurement using the Kalman gain Kₖ based on:

$${x}_{k} = {\hat{x}}_{k} + {K}_{k} {v}_{k} \qquad ( Equation 36 )$$

where
xₖ is the current estimated state vector;
\hat{x}ₖ is the current predicted state vector (Equation 31); and
vₖ is the innovation (Equation 34).

The Kalman filter may also update an estimate of the covariance matrix to reflect the reduced uncertainty after incorporating the new measurement:

$${P}_{k} = ( I - {K}_{k} H ) {\hat{P}}_{k} \qquad ( Equation 37 )$$

where
Pₖ is the current estimated covariance matrix; and
\hat{P}ₖ is the current predicted covariance matrix (Equation 32).

In one embodiment, Kalman filter may determine whether to update the Kalman filter state based on whether the innovation vₖ is within a gating window. An ellipsoidal gating function may check if innovation vₖ is within the gating window. If it is outside the ellipsoidal gating window, then the new measurement data is deemed an outlier and the Kalman filter may not update the Kalman gain Kₖ, the current estimated state vector xₖ, and the current estimated covariance matrix Pₖ. Otherwise, the Kalman filter state is updated as in equations 35, 36, and 37. The checking of whether the innovation vₖ is within a gating window may be expressed as:

$${v}_{k}^{T} {\hat{P}}_{k}^{- 1} {v}_{k} < γ \qquad ( Equation 38 )$$

where
γ is the gating window.

In one embodiment, the gating function may be configured based on the scene classification 535. In one embodiment, when scene classification 535 indicates an indoor scene indicates an indoor scene with dynamic variation, gating window γ may be larger because new measurement data may have more variance compared to that of an outdoor scene.

The Kalman filter may generate the tracker covariance coefficient 593 as Pₖ(1,1) for the confidence-based bandpass filter to adjust its bandwidth. Feature selection module with adaptive filter 540 may progressively narrow its bandwidth as the estimated covariance matrix Pₖ from the Kalman filter decreases (level of confidence in the estimated state vector xₖ increases) as a result of more range measurements being at the same target distance.

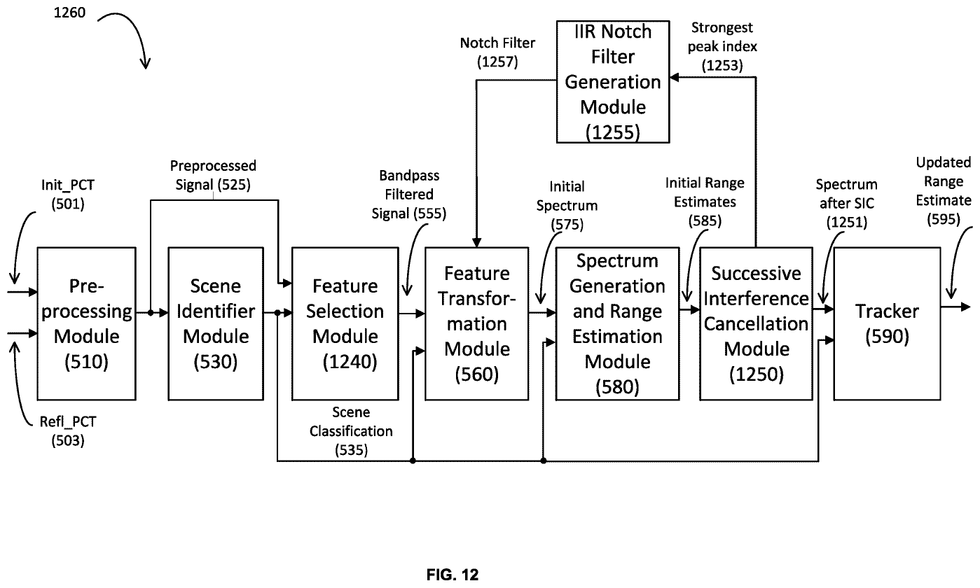

FIG. 12 illustrates a block diagram of a processing pipeline 1260 used to successively cancel strongest detected peaks from a time-domain representation of the measurement data using a notch filter to uncover a list of the closest peaks in the time-domain for range estimation, in accordance with one aspect of the present disclosure. Operations of preprocessing module 510, scene identifier module 530, feature transformation module 560, spectrum generation and range estimation module 580, and tracker module 590 have already been described when discussing the processing pipeline of FIG. 5. In one embodiment, feature selection module 1240 may operate with an adaptive bandwidth as described for feature selection module with adaptive filter 540 of FIG. 5. In one embodiment, feature selection module 1240 may operate with a fixed bandwidth for filtering the I/Q measurement data.

A successive interference cancellation (SIC) module 1250 may successfully identify frequency peaks of decreasing intensities for cancellation or removal starting from the frequency peak with the maximum intensity based on the initial spectrum 575 from feature transformation module 560 and an input specifying a maximum number of cancellations. In one embodiment, the initial spectrum 575 may be the time-domain representation of the bandpass filtered I/Q measurement data and may be referred to simply as time-domain data. In one embodiment, the maximum number of cancellations may be predefined or configured by a host of CS initiator 210. SIC module 1250 may generate a list of closest peak locations containing the indices of the sequentially closest peaks in the time-domain representation of the bandpass filtered I/Q measurement data based on the frequency peaks identified.

SIC module 1250 may initialize an empty list of closest peak locations. SIC module 1250 may perform a frequency transformation of the time-domain data to obtain a frequency domain representation. In one embodiment, the frequency transformation may be a Fast Fourier Transform (FFT). SIC module 1250 may identify a strongest peak (referred to as the current frequency peak) in the frequency-domain representation. SIC module 1250 may determine a time index in the time-domain data to represent a time-domain location corresponding to the current frequency peak.

SIC module 1250 may determine whether the time index is less than existing indices of the closest peaks in the list of closest peak locations. In one embodiment, SIC module 1250 may determine whether the time index is less than a minimum index in the list of closest peak locations. If the time index is less than a minimum index in the list of closest peak locations, the current frequency peak in the time-domain is deemed to be closer than any other peak in the list of closest peak locations. SIC module 1250 may then add the time index to the list of closest peaks locations.

SIC module 1250 may remove the current frequency peak from the time-domain data if certain criteria are satisfied. In one embodiment, the criteria may include whether a difference between the time index and one or more of the indices in the list of closest peak locations satisfies a minimum threshold. For example, whether the time index corresponding to the current frequency peak is sufficiently far away from a time index of the last detected frequency peak to preclude one peak from being considered as a multipath of the other peak. If the criteria are satisfied, an infinite impulse response (IIR) notch filter generation module 1255 may generate a notch filter 1257 based on the time index corresponding to the current frequency peak (e.g., strongest peak index 1253). In one embodiment, a finite impulse response (FIR) filter, instead of an IIR filter, may generate the notch filter 1257.

Feature transformation module 560 may apply notch filter 1257 to remove the current frequency peak from the time-domain data to generate residual time-domain representation of the bandpass filtered I/Q measurement data (referred to simply as residual time-domain data). If the energy of the residual time-domain data remains above a minimum energy threshold and a total number of peaks removed has not reached the predefined maximum number of cancellations, SIC module 1250 may perform a frequency transformation of the residual time-domain data to identify the strongest frequency peak (e.g., current frequency peak) in the residual time-domain data. SIC module 1250 may again determine a time index to represent a time-domain location corresponding to the current frequency peak, determine whether to add the time index to the list of closest peaks locations, and if certain criteria are satisfied to remove the current frequency peak from the residual time-domain data using notch filter 1257. SIC module 1250 may successively remove or cancel frequency peaks as described from the residual time-domain data up to the predefined maximum number of cancellations.

SIC module 1250 may generate spectrum after SIC 1251. In one embodiment, spectrum after SIC 1251 may contain the list of closest peaks locations. Tracker 590 may estimate the range to a target device based on the minimum time index in the list of closest peak locations where the minimum time index indicates the location of the closest peak.

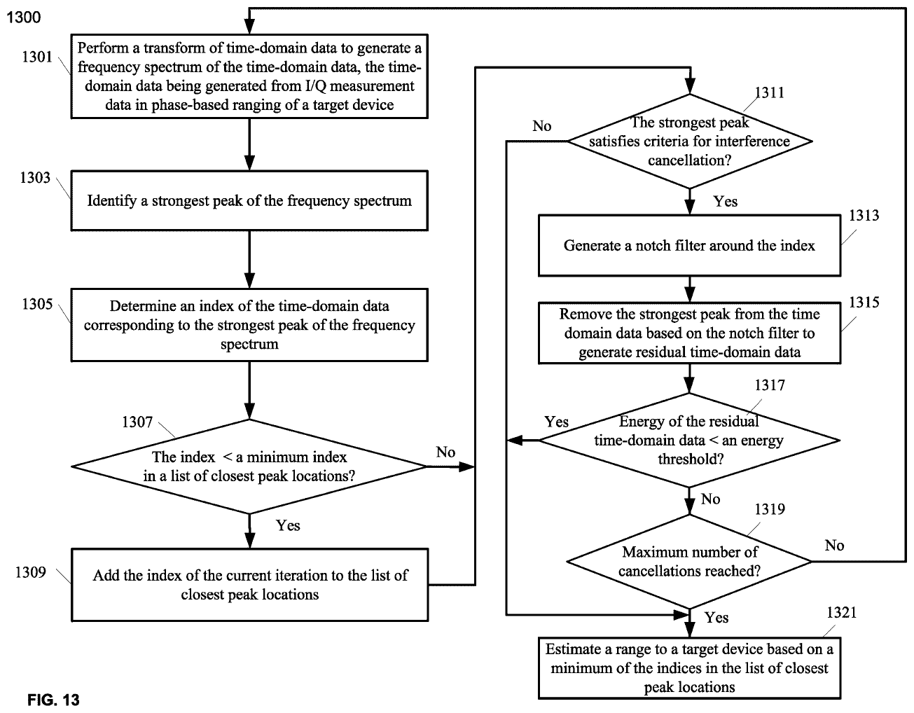

FIG. 13 illustrates a flow diagram of a method 1300 of operating the processing pipeline of FIG. 12 to successively identify and cancel strongest detected peaks from a time-domain representation of the measurement data using a notch filter to reveal a closest peak location for use in estimating a range to a target device, in accordance with one aspect of the present disclosure. In one aspect, method 1300 may be performed by an initiator such as CS initiator 210 of FIG. 2 utilizing hardware, software, or combinations of hardware and software.

In operation 1301, the initiator may perform a transform of time-domain data to generate a frequency spectrum of the time-domain data. The time-domain data are generated from I/Q phase measurement data in phase-based ranging of a target device. The time-domain data may have one or more detected peaks representing a direct path or a multipath from the target device or from an interference signal. In one embodiment, the transform may be implemented using FFT.

In operation 1303, the initiator may identify a current strongest peak of the frequency spectrum. The current strongest peak may represent a detection of an interfering signal or the target device in the frequency domain.

In operation 1305, the initiator may determine an index of the time-domain data corresponding to the current strongest peak of the frequency spectrum. The index may represent a distance to an interfering signal source or a target of interest in the time domain relative to the initiator.

In operation 1307, the initiator determines whether the index is less than a minimum index in a list of closest peak locations. The list of closest peak locations contains the indices of the sequentially closest peaks that have been detected previously in the time domain data. The minimum index represents the distance to the closest peak in the list of closest peak locations.

If the index is less than the minimum index, the current strongest peak is deemed closer than a previously detected closest peak. In operation 1309, the initiator adds the index to the list of closest peak locations. Otherwise, if the index is not less than the minimum index, the initiator does not update the list of closest peak locations.

In operation 1311, the initiator determines whether the current strongest peak satisfies criteria for interference cancellation. In one embodiment, the criteria may include if the current strongest peak is sufficiently far away from a last detected peak. In one embodiment, the criteria may include if the current strongest peak is sufficiently far away from all peaks in the list of closest peak locations. Peaks that are sufficiently far apart may be considered as representing separate signals rather than multipath reflections of one another. In one embodiment, the current strongest peak may satisfy the criteria for interference cancellation by default.

If the strongest peak satisfies the criteria for interference cancellation, in operation 1313, the initiator may generate a notch filter around the index in the time domain to cancel or remove the current strongest peak.

In operation 1315, the initiator may remove the current strongest peak from the time-domain data based on the notch filter to generate residual time-domain data.

In operation 1317, the initiator may determine if the energy of the residual time-domain data drops below an energy threshold.

If the energy of the residual time-domain data still satisfies the energy threshold, in operation 1319, the initiator may determine if a total number of frequency peaks removed reaches a predefined maximum number of cancellations.

If the total number of frequency peaks removed has not reached the predefined maximum number of cancellations, the initiator may repeat operations 1301, 1303, 1305, 1307, 1309, 1311, 1313, 1315, 1317, and 1319 to identify the strongest peak in the frequency spectrum of the residual time-domain data and may cancel the strongest peak from the residual time-domain data. The energy of the residual time-domain data may decrease after each iteration of the interference cancellation. The initiator may successively cancel the peaks in the residual time-domain data until the energy of the residual time-domain data drops below the energy threshold or until reaching the predefined maximum number of cancellations.

If the current strongest peak does not satisfy the criteria for interference cancellation in operation 1311, or if the energy of the residual time-domain data drops below the energy threshold in operation 1317, or if the predefined maximum number of peaks have been canceled in operation 1319, the initiator may estimate a range to the target device based on a minimum of the indices in the list of closest peak locations in operation 1321. The minimum index in the list of closes peak locations may represent the closest peak in the time domain data detected from the target device or an interfering signal.

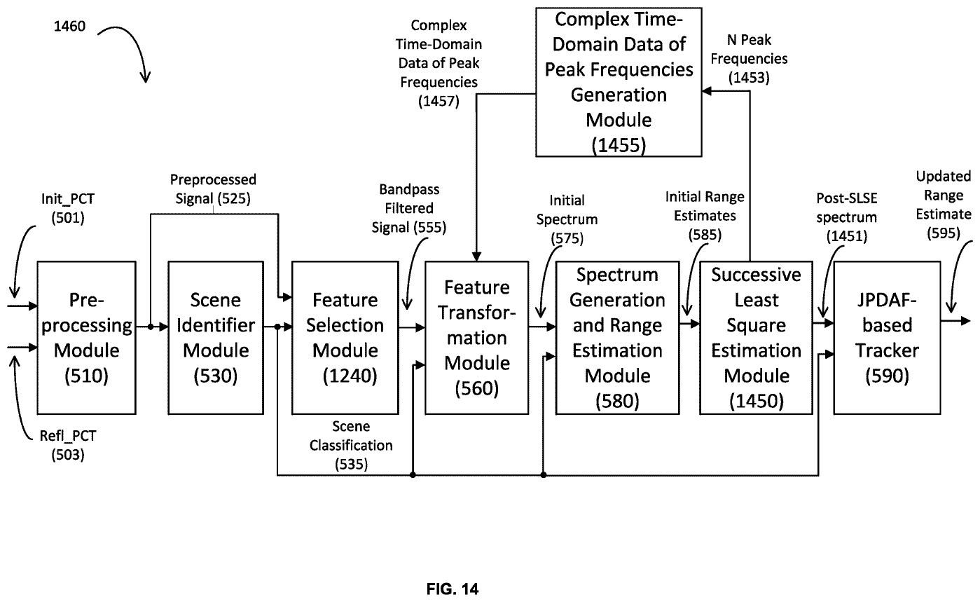

FIG. 14 illustrates a block diagram of a processing pipeline 1460 used to successively remove frequency peaks estimated to contain the maximum energy in the least squares sense from a time-domain representation of the measurement data to uncover a list of the strongest peaks in the frequency domain for range estimation, in accordance with one aspect of the present disclosure. Preprocessing module 510, scene identifier module 530, feature selection module 1240, feature transformation module 560, and spectrum generation and range estimation module 580 are the same as in FIG. 12.

A successive least squares estimation (SLSE) module 1450 may successively identify frequency peaks of decreasing energies for removal starting from the frequency peak with the maximum energy based on the initial spectrum 575 from feature transformation module 560 and an input specifying a maximum number of frequency peaks to identify. The initial spectrum 575 may be referred to as the time-domain data. In one embodiment, the maximum number of frequency peaks to identify may be predefined or configured by a host of CS initiator 210. SLSE module 1450 may identify the frequency peak that if removed will remove the maximum energy in the least squares sense. SLSE module 1450 may generate a list of peak locations containing the indices of the strongest frequency peaks and a list of peak intensities containing the corresponding intensities of the strongest frequency peaks for the maximum number of frequency peaks to identify.

SLSE module 1450 may determine a maximum intensity of the time-domain data and may normalize the time-domain data based on the maximum intensity. The maximum intensity may represent the intensity of the strongest peak in the time-domain data. SLSE module 1450 may also determine the corresponding index of the strongest peak in the time-domain data. SLSE module 1450 may determine whether the maximum intensity is more than a peak threshold. If the maximum intensity is more than the peak threshold, SLSE module 1450 may perform a frequency transformation of the time-domain data to obtain a frequency spectrum. In one embodiment, the frequency transformation may be a Fast Fourier Transform (FFT).

SLSE module 1450 may identify a frequency peak of maximum energy in the frequency spectrum. The frequency peak, if removed, may remove the maximum energy from the frequency spectrum. SLSE module 1450 may determine an index and an intensity of the frequency peak identified. SLSE module 1450 may save the index and the intensity of the frequency peak identified into the list of peak locations and the list of peak intensities. In one embodiment, SLSE module 1450 may identify the frequency peak of maximum energy using a binary search method.

A complex time-domain data of peak frequencies generation module 1455 may generate the complex time-domain data representing the index and the intensity of the frequency peak identified. In one embodiment, complex time-domain data of peak frequencies generation module 1455 may generate complex time-domain data of peak frequencies 1457 for N peak frequencies 1453 where N may be the predefined maximum number of frequency peaks to identify.

Feature transformation module 560 may subtract the complex time-domain data representing the index and the intensity of the frequency peak identified from the time-domain data to generate residual time-domain data. If the energy of the residual time-domain data remains above a minimum energy threshold and a total number of peaks subtracted has not reached the predefined maximum number of frequency peaks to identify, SLSE module 1450 may determine a maximum intensity of the residual time-domain data. The maximum intensity of the residual time-domain data may represent the intensity of the strongest peak in the residual time-domain data. SLSE module 1450 may determine a corresponding index of the strongest peak in the residual time-domain data. SLSE module 1450 may again determine whether the maximum intensity is more than a peak threshold, perform a frequency transformation of the residual time-domain data to obtain a frequency spectrum, determine an index and an intensity of a frequency peak of maximum energy in the least squares sense in the residual time-domain data, generate the complex time-domain data representing the index and the intensity of the frequency peak identified, and subtract the complex time-domain data representing the index and the intensity of the frequency peak identified from the residual time-domain data. SLSE module 1450 may successively subtract the complex time-domain data representing the frequency peaks as described from the residual time-domain data up to the predefined maximum number of frequency peaks to identify.

SLSE module 1450 may generate post-SLSE spectrum 1451. In one embodiment, post-SLSE spectrum 1451 may contain the indices of the strongest peaks in the input time-domain data and in the residual time-domain data identified in operations 1501 and 1521. The number of indices of the strongest peaks may be one more than the total number of complex time-domain data representing the indices and the intensities of the frequency peaks identified and subtracted from the input time-domain data and the residual time-domain data. In one embodiment, this number may be one plus the predefined maximum number of frequency peaks to identify.

A joint probabilistic data association filter (JPDAF)-based tracker 590 may estimate the range to a target device based on post-SLSE spectrum 1451 containing the indices of the strongest peaks. JPDAF-based tracker 590 may attempt to resolve the ambiguous association of predicted tracker states with measurement data due to more than one target under consideration, false alarms, or an environment cluttered by interfering signals.

During an initialization stage, JPDAF-based tracker 590 may set up filters for each exiting track. In one embodiment, the filters may be Kalman filters. JPDAF-based tracker 590 may initialize the track states and the covariance matrices for the filter. JPDAF-based tracker 590 may define detection validation gate. In one embodiment, the detection validation gate may be an area around a predicted target position.

During a measurement preprocessing stage, JPDAF-based tracker 590 my receive new sensor measurements, such as the indices of the strongest peaks received from the SLSE module 1450. JPDAF-based tracker 590 may validate the measurements against the detection gate for each track.

During a joint event hypothesis generation stage, JPDAF-based tracker 590 may define all possible joint events. For example, JPDAF-based tracker 590 may assign each measurement to at most one target. JPDAF-based tracker 590 may also assign each target to a unique measurement, where the measurement may be “no detection.”

During a hypothesis probability calculation stage, for each joint event, JPDAF-based tracker 590 may calculate the probability of the joint event based on one or more of track prediction accuracy, measurement likelihood, probability of detection (Pd), or probability of false alarm (Pfa), etc. In one embodiment, the measurement likelihood may be a function of target-to-measurement distance.

During a marginal probability calculation stage, for each track, JPDAF-based tracker 590 may sum the probabilities of all joint events where the track is associated with a measurement. JPDAF-based tracker 590 may also, for each track, calculate the probability of the track being undetected (e.g., track is not associated with a measurement).

During a track updating stage, for each track associated with a measurement, JPDAF-based tracker 590 may update the track state and the covariance matrix using the chosen filter (e.g., Kalman filter update). For each track not associated with a measurement, JPDAF-based tracker 590 may perform state prediction based on the filter's motion model.

During a track management stage, JPDAF-based tracker 590 may check for track detection based on criteria. In one embodiment, the criteria may include missed detections for a prolong period of time. In one embodiment, JPDAF-based tracker 590 may consider initiating new tracks that are persistently not associated with measurements.

JPDAF-based tracker 590 may repeat the measurement preprocessing stage, joint event hypothesis generation stage, hypothesis probability calculation stage, marginal probability calculation stage, track updating stage, and track management stage for each set of sensor measurement.

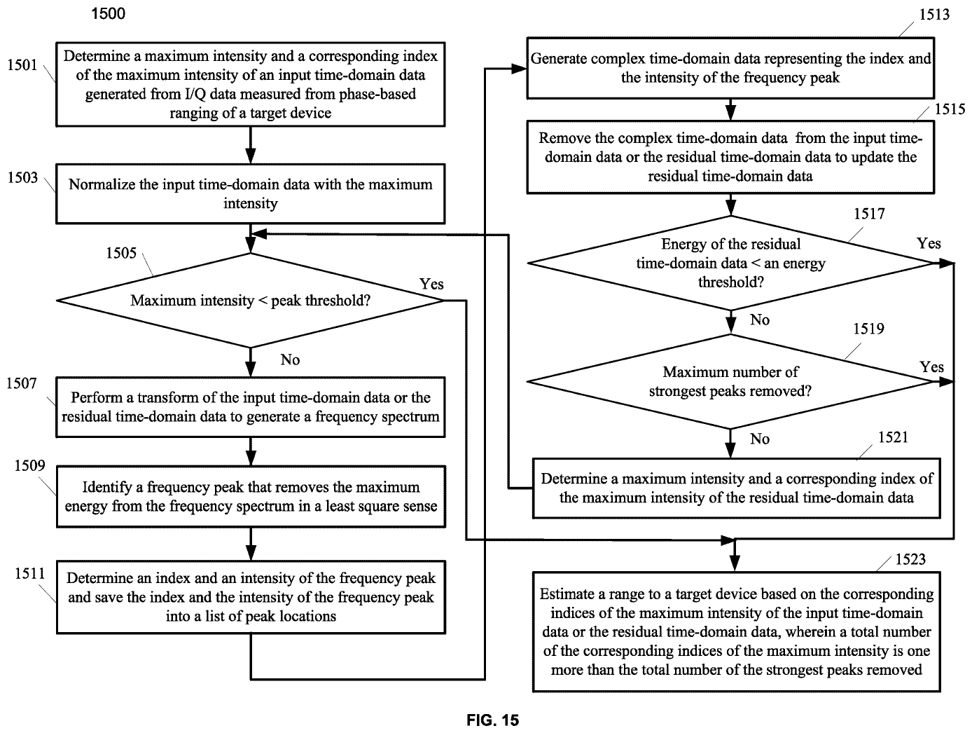

FIG. 15 illustrates a flow diagram of a method 1500 of operating the processing pipeline of FIG. 14 to successively identify and remove strongest detected frequency peaks from a time-domain representation of the measurement data to generate a list of the strongest peaks in the frequency domain for use in estimating a range to a target device, in accordance with one aspect of the present disclosure. In one aspect, method 1500 may be performed by an initiator such as CS initiator 210 of FIG. 2 utilizing hardware, software, or combinations of hardware and software.

In operation 1501, the initiator may determine a maximum intensity and a corresponding index of the maximum intensity of an input time-domain data. The input time-domain data are generated from I/Q phase measurement data in phase-based ranging of a target device. The input time-domain data may have one or more detected peaks representing a direct path or a multipath from the target device or from an interference signal. The maximum intensity may represent the intensity of the strongest peak in the input time-domain data. The strongest peak in the input time-domain data may represent a detection of an interfering signal or the target device.

In operation 1503, the initiator may normalize the input time-domain data with the maximum intensity.

In operation 1505, the initiator may determine whether the maximum intensity is less than a peak threshold. In one embodiment, the peak threshold may be set at 0.225

If the maximum intensity is not less than the peak threshold, the initiator may perform a frequency transformation of the time-domain data to obtain a frequency spectrum. In one embodiment, the frequency transformation may be a Fast Fourier Transform (FFT).

In operation 1509, the initiator may identify a frequency peak that, if removed, removes the maximum energy from the frequency spectrum in a least squares sense. The frequency peak of maximum energy identified in the frequency spectrum may not correspond to the strongest peak in the time-domain data identified in operation 1501.

In operation 1511, the initiator may determine an index and an intensity of the frequency peak identified in operation 1509. The initiator may save the index of the frequency peak into a list of peak locations. The list of peak locations store the indices of the N strongest peaks in the frequency spectrum. In one embodiment, N may be predefined or configurable. The initiator may save the intensity of the frequency peak into a list of peak intensities. The list of peak intensities store the corresponding intensities of the N strongest peaks.

In operation 1513, the initiator may generate complex time-domain data representing the index and the intensity of the frequency peak.

In operation 1515, the initiator may remove the complex time-domain data representing the index and the intensity of the frequency peak from the input time-domain data to generate residual time-domain data.

In operation 1517, the initiator may determine whether energy of the residual time-domain data drops to below an energy threshold.

If the energy of the residual time-domain data still satisfies the energy threshold, in operation 1519, the initiator may determine if a total number of frequency peaks removed reaches a predefined maximum number of frequency peaks to remove. In one embodiment, the predefined maximum number of frequency peaks to remove may be the number of the strongest peaks (e.g., N) stored by the list of peak locations and the list of peak intensities.

If the total number of frequency peaks removed has not reaches the predefined maximum number, in operation 1521, the initiator may determine a maximum intensity and a corresponding index of the maximum intensity of the residual time-domain data. The initiator may repeat operations 1505, 1507, 1509, 1511, 1513, 1515, 1517, and 1519 to identify a frequency peak of maximum energy in the least squares sense in the frequency spectrum of the residual time-domain data and may remove the frequency peak of maximum energy identified from the residual time-domain data. The energy of the residual time-domain data may decrease after each removal of a frequency peak. The initiator may successively remove the frequency peaks in the residual time-domain data until the energy of the residual time-domain data drops below the energy threshold or until reaching the predefined maximum number of frequency peaks to remove.

If the maximum intensity of the input time-domain data or the residual time-domain data is less than the peak threshold in operation 1505, or if the energy of the residual time-domain data drops below the energy threshold in operation 1517, or if the predefined maximum number of frequency peaks have been removed in operation 1519, the initiator may estimate a range to the target device in operation 1523. The initiator may estimate the range to the target device based on the corresponding index of the maximum intensity of the input time-domain data determined in operation 1501 or the corresponding indices of the maximum intensity of the residual time-domain data determined in operation 1521. In one embodiment, the total number of the corresponding indices of the maximum intensities may be one plus the total number of frequency peaks removed. In one embodiment, the total number of the corresponding indices of the maximum intensities may be N+1, where N is the number of the strongest peaks stored by the list of peak locations and the list of peak intensities.

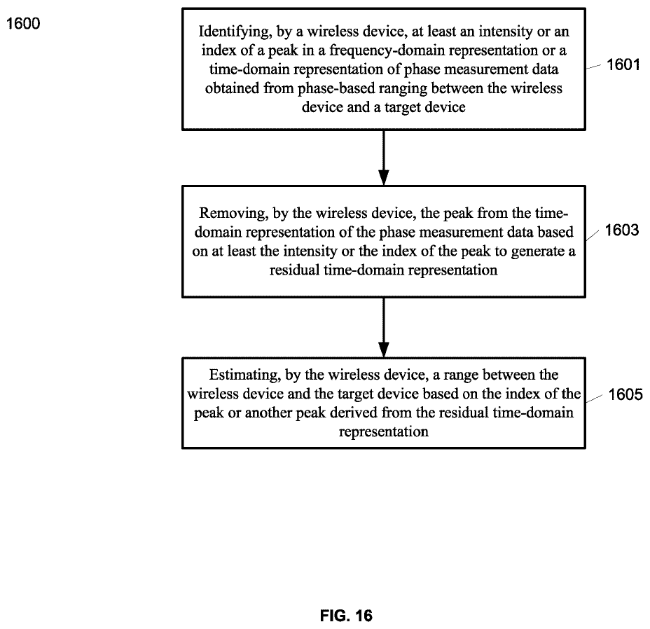

FIG. 16 illustrates a flow diagram of a method 1600 for operating a device to identify and remove a detected frequency peak from the time-domain representation of phase measurement data to estimate a range between the device and a target device, in accordance with one aspect of the present disclosure. In one aspect, method 1600 may be performed by a wireless device such as CS initiator 210 of FIG. 2 utilizing hardware, software, or combinations of hardware and software.

In operation 1601, the wireless device may identify at least an intensity or an index of a peak in a frequency-domain representation or a time-domain representation of phase measurement data obtained from phase-based ranging between the wireless device and a target device.

In operation 1603, the wireless device may remove the peak from the time-domain representation of the phase measurement data based on at least the intensity or the index of the peak to generate a residual time-domain representation.

In operation 1605, the wireless device my estimate a range between the wireless device and the target device based on the index of the peak or another peak derived from the residual time-domain representation.

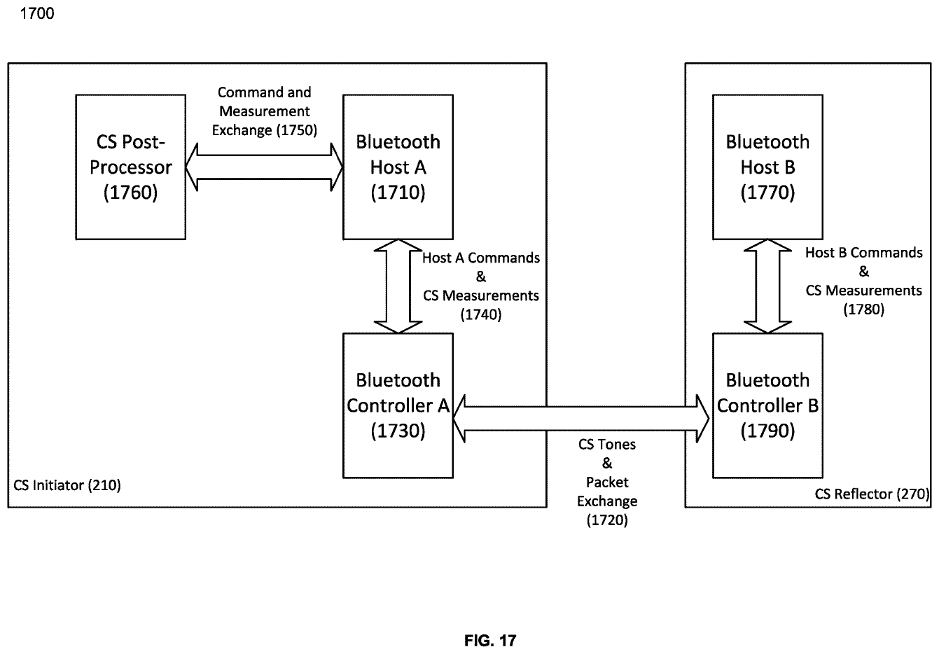

FIG. 17 illustrates a functional block diagram of two Bluetooth devices 210 and 270 that implement phase-based ranging using channel sounding (CS) and CS post-processing of the phase measurement data to estimate a range between the two devices, in accordance with one aspect of the present disclosure.

A CS initiator 210 may have a Bluetooth controller A 1730, a Bluetooth host A 1710, and a CS post-processor 1760. A CS reflector 270 may have a Bluetooth controller B 1790 and a Bluetooth host B 1770. Bluetooth controller A 1730 and Bluetooth controller B 1790 may exchange constant tones and packets on multiple channel frequencies 1720 in a ranging cycle using a channel shuffling mechanism. In one embodiment, the two device may exchange 72 constant tone signals across the 80 MHz of the entire 2.4 GHz ISM band in BLE to determine a wideband frequency transfer function of the channel. Bluetooth controller B 1790 may transmit its measured phase of the received constant tone signals to Bluetooth controller A 1730.

Bluetooth controller A 1730 may receive host commands from Bluetooth host A 1710 through an initiator communication interface 1740 to perform the operations of the ranging cycle. Similarly, Bluetooth controller B 1790 may receive host commands from Bluetooth host B 1770 through a reflector communication interface 1780 to perform the ranging cycle operations. Bluetooth controller B 1790 may transmit its phase measurements to its Bluetooth host B 1770 through reflector communication interface 1780 for processing such as during the calibration-synchronization timeslot. Bluetooth controller A 1730 may transmit its phase measurements and the phase measurements received from Bluetooth controller B 1790 to Bluetooth host A 1710 through initiator communication channel 1740 for processing. Bluetooth host A 1710 may process the phase measurements exchanged during the ranging cycle to estimate the range or may invoke CS post-processor 1760 to process the phase measurements. Bluetooth host A 1710 or CS post-processor 1760 may process the phase measurements as described for operations of FIGS. 5-16 utilizing hardware, software, or combinations of hardware and software.

Various embodiments of the multi-carrier phase-based ranging system described herein may include various operations. These operations may be performed and/or controlled by hardware components, digital hardware and/or firmware/programmable registers (e.g., as implemented in computer-readable medium), and/or combinations thereof. For example, the operations may be performed by a general-purpose computer or a processing system executing computer program stored in a computer-readable medium. The methods and illustrative examples described herein are not inherently related to any particular device or other apparatus. Various systems (e.g., such as a wireless device operating in a near or long field environment, pico area network, wide area network, etc.) may be used in accordance with the teachings described herein, or it may prove convenient to construct more specialized apparatus to perform the required method steps. The required structure for a variety of these systems will appear as set forth in the description above.

A computer-readable medium used to implement operations of various aspects of the disclosure may be non-transitory computer-readable storage medium that may include, but is not limited to, electromagnetic storage medium, magneto-optical storage medium, read-only memory (ROM), random-access memory (RAM), erasable programmable memory (e.g., EPROM and EEPROM), flash memory, or another now-known or later-developed non-transitory type of medium that is suitable for storing configuration information.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “may include”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing. For example, certain operations may be performed, at least in part, in a reverse order, concurrently and/or in parallel with other operations.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component.

Additionally, “configured to” or “configurable to” can include generic structure (e.g., generic circuitry) that is manipulated by firmware (e.g., an FPGA) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method of operations by a wireless device, comprising:
identifying at least an intensity or an index of a peak in a frequency-domain representation or a time-domain representation of phase measurement data obtained from phase-based ranging between the wireless device and a target device;
removing the peak from the time-domain representation of the phase measurement data based on at least the intensity or the index of the peak to generate a residual time-domain representation; and
estimating a range between the wireless device and the target device based on the index of the peak or another peak derived from the residual time-domain representation.

2. The method of claim 1, wherein identifying at least an intensity or an index of a peak comprises:
transforming the time-domain representation to the frequency-domain representation using a Fast Fourier Transform (FFT);
identifying a strongest peak in the frequency-domain representation;
determining a time index of a peak in the time-domain representation, wherein the time index represents a time-domain location corresponding to the strongest peak in the frequency-domain representation;
determining whether the time index is less than a minimum of indices in a list of closest peak locations; and
adding the time index to the list of closest peak locations in response to the time index being less than the minimum.

3. The method of claim 2, wherein removing the peak from the time-domain representation comprises:
determining whether a difference between the time index and one or more of the indices in the list of closest peak locations satisfies a condition;
generating a notch filter based on the time index in response to the difference satisfying the condition; and
generating the residual time-domain representation by filtering the time-domain representation based on the notch filter to remove the strongest peak.

4. The method of claim 3, wherein the condition comprises a minimum time separation between the time index and the one or more indices in the list of closest peak locations.

5. The method of claim 2, wherein removing the peak from the time-domain representation comprises:
canceling interference from the time-domain representation.

6. The method of claim 1, further comprising:
determining whether an energy level of the residual time-domain representation satisfies an energy threshold;
determining whether a total number of peaks removed from the time-domain representation is less than a maximum number; and
successively identifying an index of a next peak in the residual time-domain representation and removing the next peak from the residual time-domain representation based on the index of the next peak in response to the energy level of the residual time-domain representation satisfying the energy threshold and the total number of peaks removed being less than the maximum number.

7. The method of claim 2, wherein estimating a range between the wireless device and the target device comprises:
determining whether an energy level of the residual time-domain representation is less than an energy threshold or whether a total number of peaks removed from the time-domain representation reaches a maximum number; and
estimating the range based on a minimum time index in the list of closest peak locations in response to the energy level of the residual time-domain representation being less than the energy threshold or the total number of peaks removed reaching the maximum number.

8. The method of claim 1, wherein identifying at least an intensity or an index of a peak comprises:
identifying an intensity of a strongest peak in the time-domain representation;
identifying a time index of the strongest peak in the time-domain representation;
normalizing the time-domain representation based on the intensity;
determining whether the intensity of the strongest peak satisfies a peak threshold;
transforming the time-domain representation to the frequency-domain representation in response to the intensity of the strongest peak satisfying the peak threshold;
identifying a strongest frequency peak in the frequency-domain representation;
identifying a frequency index and an intensity of the strongest frequency peak; and
saving the frequency index and the intensity of the strongest frequency peak into a list of strongest frequency peak locations.

9. The method of claim 8, wherein identifying a strongest frequency peak in the frequency-domain representation comprises:
identifying a strongest frequency peak that corresponds to a maximum energy in a least squares sense among one or more peaks in the frequency-domain representation.

10. The method of claim 8, wherein removing the peak from the time-domain representation comprises:
generating a time-domain peak data based on the frequency index and the intensity of the strongest frequency peak; and
generating the residual time-domain representation by subtracting the time-domain peak data from the time-domain representation to remove the strongest frequency peak.

11. The method of claim 8, further comprising:
determining whether an energy level of the residual time-domain representation satisfies an energy threshold;
determining whether a total number of peaks removed from the time-domain representation is less than a maximum number; and
successively identifying a frequency index and an intensity of a next strongest frequency peak in a frequency transform of the residual time-domain representation and removing the next strongest peak from the residual time-domain representation based on the frequency index and the intensity of the next strongest frequency peak in response to the energy level satisfying the energy threshold and the total number of peaks removed being less than the maximum number.

12. The method of claim 8, wherein estimating a range between the wireless device and the target device comprises:
determining whether an energy level of the residual time-domain representation is less than an energy threshold or whether a total number of peaks removed from the time-domain representation reaches a maximum number of peaks; and
estimating the range based on one or more of the time indices of the strongest peaks in response to the energy level of the residual time-domain representation being less than the energy threshold or the total number of peaks removed reaching the maximum number of peaks, wherein a total number of the time indices comprises a total number of peaks removed.

13. The method of claim 12, wherein estimating the range based on one or more of the time indices of the strongest peaks comprises:
processing the one or more of the time indices of the strongest peaks based on a joint probabilistic data association filter (JPDAF).

14. An apparatus comprising:
a processing system configured to:
identify at least an intensity or an index of a peak in a frequency-domain representation or a time-domain representation of phase measurement data obtained from phase-based ranging between the apparatus and a target device;
remove the peak from the time-domain representation of the phase measurement data based on at least the intensity or the index of the peak to generate a residual time-domain representation; and
estimate a range between the apparatus and the target device based on the index of the peak or another peak derived from the residual time-domain representation.

15. The apparatus of claim 14, wherein to identify at least an intensity or an index of a peak, the processing system is configured to:
transform the time-domain representation to the frequency-domain representation using a Fast Fourier Transform (FFT);
identify a strongest peak in the frequency-domain representation;
determine a time index of a peak in the time-domain representation, wherein the time index represents a time-domain location corresponding to the strongest peak in the frequency-domain representation;
determine whether the time index is less than a minimum of indices in a list of closest peak locations; and
add the time index to the list of closest peak locations in response to the time index being less than the minimum.

16. The apparatus of claim 15, wherein to remove the peak from the time-domain representation, the processing system is configured to:
determine whether a difference between the time index and one or more of the indices in the list of closest peak locations satisfies a condition;
generate a notch filter based on the time index in response to the difference satisfying the condition; and
generate the residual time-domain representation by filtering the time-domain representation based on the notch filter to remove the strongest peak.

17. The apparatus of claim 14, wherein the processing system is further configured to:
determine whether an energy level of the residual time-domain representation satisfies an energy threshold;
determine whether a total number of peaks removed from the time-domain representation is less than a maximum number; and
successively identify an index of a next peak in the residual time-domain representation and removing the next peak from the residual time-domain representation based on the index of the next peak in response to the energy level of the residual time-domain representation satisfying the energy threshold and the total number of peaks removed being less than the maximum number.

18. The apparatus of claim 14, wherein to identify at least an intensity or an index of a peak, the processing system is configured to:
identify an intensity of a strongest peak in the time-domain representation;
identify a time index of the strongest peak in the time-domain representation;
normalize the time-domain representation based on the intensity;
determine whether the intensity of the strongest peak satisfies a peak threshold;
transform the time-domain representation to the frequency-domain representation in response to the intensity of the strongest peak satisfying the peak threshold;
identify a strongest frequency peak in the frequency-domain representation;
identify a frequency index and an intensity of the strongest frequency peak; and
save the frequency index and the intensity of the strongest frequency peak into a list of strongest frequency peak location.

19. The apparatus of claim 18, wherein to remove the peak from the time-domain representation, the processing system is configured to:
generate a time-domain peak data based on the frequency index and the intensity of the strongest frequency peak; and
generate the residual time-domain representation by subtracting the time-domain peak data from the time-domain representation to remove the strongest frequency peak.

20. A system comprising:
a host device;
an initiator device configured to exchange ranging signals with a reflector device in phase-based ranging (PBR) to obtain phase measurement data; and
a processing system configured to:
identify at least an intensity or an index of a peak in a frequency-domain representation or a time-domain representation of the phase measurement data;
remove the peak from the time-domain representation of the phase measurement data based on at least the intensity or the index of the peak to generate a residual time-domain representation; and
estimate a range between the initiator device and the reflector device based on the index of the peak or another peak derived from the residual time-domain representation.
